(19) United States
(12) Patent Application Publication
(10) Pub. No.: US 2012/0078440 A1
(43) Pub. Date: Mar. 29, 2012

(54) METHODS AND SYSTEMS FOR INTEGRATION OF VEHICLE SYSTEMS

(75) Inventors: John M. Oravis, Franklinville, NJ (US); Scott F. Brams, Elkins Park, PA (US)

(73) Assignee: Force Protection Technologies, Inc.

(21) Appl. No.: 13/242,133

(22) Filed: Sep. 23, 2011

Related U.S. Application Data
(60) Provisional application No. 61/386,903, filed on Sep. 27, 2010.

(51) Int. Cl. G06F 17/00; G06F 3/048

(52) U.S. Cl. 701/1; 715/781

(57) ABSTRACT

In one aspect, an information terminal of a vehicle has a display device and a vehicle interface connecting to a plurality of distinct vehicle communications platforms supporting a plurality of vehicle systems. It also has a storage device storing an operating system of the vehicle information terminal, a plurality of graphical operator interface (GUI) applications corresponding to the vehicle systems and configured to execute on the operating system, and one or more processors. The one or more processors are configured to execute the GUI application on the operating system to display a GUI window on the display device, the GUI window providing for an operator's selection at least some of the plurality of GUI applications, to receive a selection by the operator of a GUI application, and to interface with the vehicle system to which the selected GUI application corresponds over the vehicle communications platform via the GUI window.

### PRIORITY CLAIM

This application claims the benefit of priority to U.S. Provisional Application No. 61/386,903, filed Sep. 27, 2010. The content of this provisional application is incorporated herein by reference in its entirety.

### TECHNICAL FIELD

This disclosure relates to vehicles and, more specifically, to methods and systems for integrating systems of a vehicle using an onboard vehicle information terminal computer.

### BACKGROUND

Modern vehicles are equipped with numerous onboard systems that perform various functions. For example, a passenger vehicle may have an engine control system, a transmission control system, an airbag control system, a fuel injection system, an anti-lock brake system, and/or other onboard systems that perform specialized tasks during operation and maintenance of the vehicle. These onboard systems are usually interconnected via a data bus, such as a Controller Area Network (CAN) bus, and include one or more Electronic Control Units (ECUs) configured to communicate on the bus for controlling the various functions of the onboard systems.

Specialized vehicles—such as military vehicles, construction equipment, and agricultural equipment—may include a number of additional digital systems which augment the core mission-specific capabilities of a vehicle. For example, in addition to the “automotive” systems noted above, a military protected vehicle may be equipped with an Inertial Navigation System (INS), a power management system, a situational awareness system, an effects system, a communications system, and/or other specialized systems for use in relevant mission environments. Depending upon the particular environment and/or mission for which the specific vehicle is intended, manufactures sometimes offer a variety of models equipped with different selections of such onboard systems.

Such onboard systems of specialized vehicles are “stove-piped.” That is, they operate on specialized or incompatible “legacy” platforms and lack the ability to work collaboratively for optimal effectiveness of the vehicle. For example, the navigation system, video surveillance system, and radio communication system may operate on a serial communications platform, such as the Electronics Industry Association (EIA) standard 232. The automotive systems of the protected vehicle, on the other hand, may operate on a standard CAN platform. Further, the effects system and power distribution system may operate on additional CAN platforms. Aside from operating on different platforms, each onboard system has its own, independent operator interface for controlling the system and/or accessing the data output by the system, making it accessible only at its point of installation in the vehicle (e.g., the dashboard). Accordingly, a particular system may or may not be available to an operator aboard the vehicle depending upon his or her position and the location of the control interlace of the system. These and other factors have hindered the integration of specialized vehicle systems and, thus, overall vehicle effectiveness.

In certain scenarios it is desirable, or even critical, to have immediate, safe, and convenient access to and/or control over the onboard systems of a specialized vehicle. For example, during a mission, it is important that a vehicle commander have convenient access to the vehicle's laser range finder regardless of his or her position and the location of the control interface of the effects system. Or the commander's duties may require access to onboard systems outside the commander's reach, such as the situational awareness system. At the same time, other crew members may require use of systems of the vehicle that are not easily accessible from their positions aboard the vehicle. The different vehicle systems may also receive or generate important data that is useful or even critical to certain crew members. But due to the independent platforms and control interfaces of the disparate vehicle systems, centralized access and control of the systems, as well as centralized and uniform data management aboard the vehicle, have heretofore been difficult or impossible.

This disclosure is directed to overcoming one or more of the problems set forth above, as well as other problems in the art.

### SUMMARY

One aspect of the disclosure relates to a vehicle information terminal. The vehicle information terminal may include a display device and a vehicle interface connecting to a plurality of distinct vehicle communications platforms supporting a plurality of vehicle systems. It may also have a storage device storing an operating system of the vehicle information terminal, a plurality of graphical operator interface (GUI) applications corresponding to the vehicle systems and configured to execute on the operating system, and one or more processors. The one or more processors may be configured to execute the GUI application on the operating system to display a GUI window on the display device, the GUI window providing for an operator's selection at least some of the plurality of GUI applications, to receive a selection by the operator of a GUI application, and to interface with the vehicle system to which the selected GUI application corresponds over the vehicle communications platform via the GUI window.

Another aspect of the disclosure relates to a vehicle information terminal. The vehicle information terminal may include a display device, a first vehicle interface connecting to a first vehicle communications platform supporting a first set of vehicle systems, and a second vehicle interface connecting to a second vehicle communications platform supporting a second set of vehicle systems. It may also have a storage device storing an operating system of the information terminal, a mobile operating system executing within the operating system of the vehicle information terminal, a first graphical operator interface (GUI) application associated with a first vehicle system in the first set of systems and configured to execute on the mobile operating system, and a second GUI application associated with the a second vehicle system in the second set of systems and configured to execute on the mobile operating system. The vehicle information terminal may also have one or more processors configured to execute the first and second GUI applications on the mobile operating system to display first and second GUI windows on the display device associated respectively with the first and second vehicle systems, and to interface respectively with the first and second vehicle systems over the first and second vehicle communications platforms via the first and second GUI windows.

Yet another aspect relates to a method for integrating systems of a vehicle using a vehicle information terminal. In one embodiment, the method may include using a first vehicle interface, connecting to a first vehicle communications platform supporting a first set of vehicle systems, and using a second vehicle interface, connecting to a second vehicle communications platform supporting a second set of vehicle systems. The method may further include executing, by one or more processors, an operating system of the information terminal, and executing, by the one or more processors, a mobile operating system on the operating system of the vehicle information terminal. The method may also include executing, by the one or more processors on the mobile operating system, a first graphical operator interface (GUI) application associated with a first vehicle system in the first set of systems and a second GUI application associated with the a second vehicle system in the second set of systems on the mobile operating system. This execution may cause display first and second GUI windows on the display device associated respectively with the first and second vehicle systems, and may interface respectively with the first and second vehicle systems over the first and second vehicle communications platforms via the first and second GUI windows.

Yet another aspect relates to a method for integrating systems of a vehicle using a vehicle information terminal. The method may include, using a vehicle interface, connecting to a plurality of distinct vehicle communications platforms supporting a plurality of vehicle systems, and executing, by at least one processor, a mobile operating system of the vehicle information terminal. The method may further include receiving from an operator a selection of one of a plurality of graphical operator interface (GUI) applications for interlacing with one or more of the vehicle systems, and executing the selected GUI application on the mobile operating system to interface, over the vehicle communications platform, with a vehicle system of the plurality of vehicle systems to which the selected GUI application corresponds.

It is to be understood that both the foregoing general description and the following detailed description are exemplary and explanatory only, and are not restrictive of the invention, as claimed.

The accompanying drawings, which are incorporated in and constitute a part of this specification, illustrate several embodiments of the claimed invention and, together with the description, serve to explain the principles of the invention.

### BRIEF DESCRIPTION OF THE DRAWINGS

FIG. 1 shows a representation of an exemplary vehicle;

FIG. 2 illustrates a representation of an exemplary vehicle integration system for use with the vehicle, consistent with the disclosed embodiments;

FIG. 3 illustrates a representation of an exemplary vehicle information terminal of the system of the vehicle integration system, consistent with the disclosed embodiments;

FIG. 4 illustrates a representation of exemplary information stored in a storage device associated with the vehicle integration terminal, consistent with the disclosed embodiments;

FIG. 5 illustrates a representation of exemplary software architecture associated with the vehicle information terminal, consistent with the disclosed embodiments;

FIGS. 6 and 7 illustrate representations of an exemplary display window of an automotive management graphical operator interface (GUI) application that may be executed by the vehicle information terminal, consistent with the disclosed embodiments;

FIG. 8 illustrates a representation of an exemplary display window of a situational awareness GUI application that may be executed by the vehicle information terminal, consistent with the disclosed embodiments;

FIG. 9 illustrates a representation of an exemplary display window of a power management GUI application that may be executed by the vehicle information terminal, consistent with the disclosed embodiments;

FIG. 10 illustrates a representation of an exemplary display window of a remote radio control GUI application that may be executed by the vehicle information terminal, consistent with the disclosed embodiments;

FIG. 11 illustrates a representation of an exemplary display window of a navigation GUI application that may be executed by the vehicle information terminal, consistent with the disclosed embodiments;

FIG. 12 is a flowchart illustrating an exemplary method performed by the vehicle information terminal for displaying information received from different vehicle communications platforms via a UI element of a GUI application of the vehicle information terminal, consistent with the disclosed embodiments;

FIG. 13 is a flowchart illustrating an exemplary method performed by the vehicle integration terminal for commanding an onboard system of the vehicle using a UI element of a GUI application of the vehicle information terminal, consistent with the disclosed embodiments;

FIG. 14 is a flowchart illustrating an exemplary data management method performed by the vehicle information terminal, consistent with the disclosed embodiments; and

FIG. 15 illustrates a representation of an exemplary vehicle platform capability management window of a platform capability management application executed by the vehicle information terminal, consistent with the disclosed embodiments;

### DESCRIPTION OF THE EMBODIMENTS

Reference will now be made in detail to the present embodiments of the invention examples of which are illustrated in the accompanying drawings. Wherever possible, the same reference numbers will be used throughout the drawings to refer to the same or like parts.

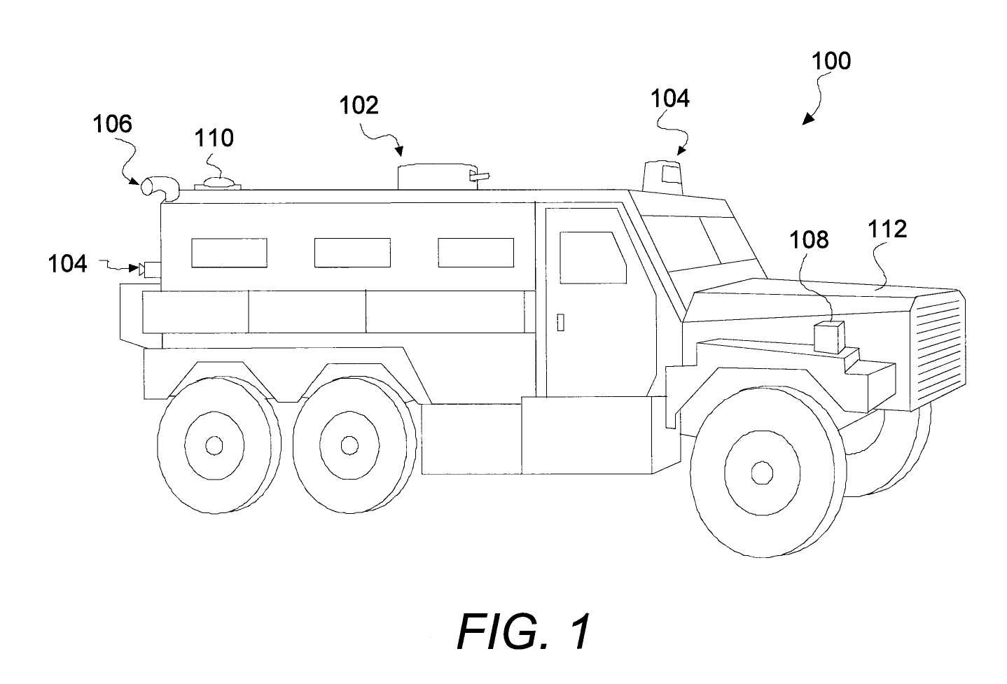

FIG. 1 illustrates a representation of an exemplary vehicle 100 to which the disclosed systems and methods may be applicable. Although vehicle 100 is illustrated as a military protected vehicle, it is to be appreciated that the disclosed embodiments may be equally applicable to construction equipment, marine systems, aircraft, passenger vehicles, and/or any other type of vehicle equipped with a variety of onboard systems configured to perform specialized tasks. The disclosed embodiments may be particularly applicable, however, to vehicles with systems operating on different platforms that generate data that may be useful or critical to passengers aboard the vehicle, such as in the case of a military protected vehicle.

As shown in FIG. 1, vehicle 100 may be equipped with a variety of onboard systems. For example, vehicle 100 may be a military vehicle and include an effects system 102 (e.g., a laser range finder), a vision enhancement system 104, and a gunfire detection system 108. Vehicle 100 may also be equipped a communications system 106, a navigation system 110, and/or a vehicle health system 112. It is to be appreciated that vehicle 100 may include additional or different systems depending upon the type of vehicle, the particular model or configuration, and/or the environment in which vehicle 100 is intended to be operated. Indeed, the particular examples of onboard systems illustrated in FIG. 1, or otherwise identified or described in this application, are intended just for illustrating aspects of the disclosure, rather than to limit the disclosure in any way.

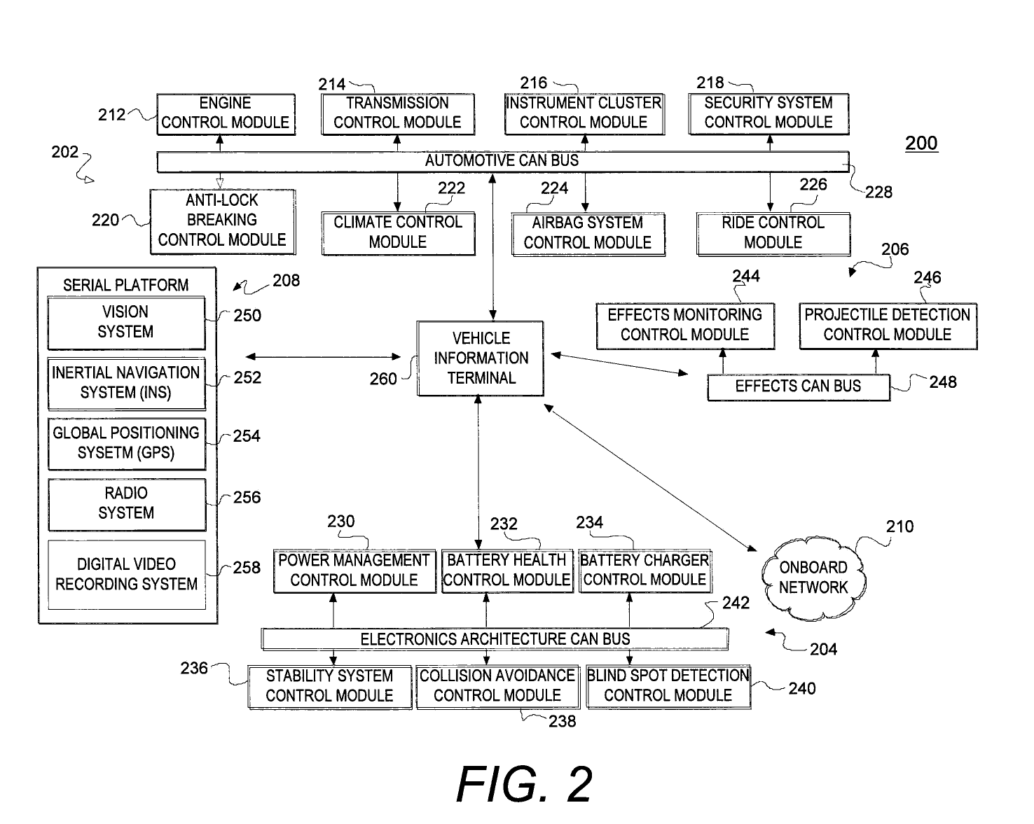

FIG. 2 illustrates a representation of an exemplary vehicle integration system 200, consistent with the disclosed embodiments. As discussed in further detail below, vehicle integration system 200 may include one or more vehicle information terminals (VITs) 260 configured execute one or more graphical operator interface (GUI) applications to conveniently integrate various onboard systems of vehicle 100 operating on different platforms for access and control by passengers. Specifically, VIT 260 may be configured to execute one or more graphical operator interface (GUI) software applications to provide a team member or operator aboard vehicle 100 with centralized, convenient access to and/or control over the vehicle systems. In one embodiment, multiple VITs 260 may be positioned on vehicle 100 for convenient operator access, e.g., one at each operator station. But in other embodiments, vehicle 100 may include just a single VIT 260 that functions as a centralized “hub” computer.

As shown in FIG. 2, integration system 200 may include various systems operating on different platforms 202-210. For example, integration system 200 may include onboard platforms such as an automotive CAN bus platform 202, an electronics architecture CAN bus platform 204, an effects system CAN bus platform 206, a serial bus platform 208, and/or an onboard local network 210.

Automotive CAN bus platform 202 may include systems onboard vehicle 100 configured to perform or control various automotive functions of vehicle 100. For example, automotive CAN bus platform 202 may include an engine control module 212, a transmission control module 214, an instrument cluster control module 216, a security system control module 218, an antilock braking system (ABS) control module 220, a climate control module 222, an airbag system control module 224, and/or a ride control module 226 interconnected via an automotive CAN bus 228. One of ordinary skill in the art will appreciate, however, that automotive CAN bus platform 202 may include additional and/or different control modules for controlling automotive functions of vehicle 100 other than the examples illustrated in FIG. 2, depending on the vehicle configuration.

Modules 212-226 may each include an electronic control unit (ECU)—such as an application-specific integrated circuit (ASIC), a field-programmable gate array (FPGA), or another type of integrated circuit or computer processing device—executing automotive software or computer program instructions. Modules 212-226 may be configured to control respective onboard systems that perform certain automotive functions associated with vehicle 100.

For example, engine control module 212 may receive signals from vehicle sensors (not shown) indicating engine speed, requested throttle amount, groundspeed, air intake, and/or other engine parameters. Engine control module 212 may receive the signals from the sensors directly, and/or may receive the signals indirectly from other modules on automotive CAN bus 228. Based on the signals and on predetermined maps stored in associated memory, engine control module 212 may calculate values of one or more control parameters of the engine, such as fuel injection amount, timing, and/or mixture. Engine control module 212 may then control the engine based on the calculated values. Further, engine control module 212 may periodically broadcast messages on CAN bus 228 indicating values of the sensed and/or calculated parameters for use by the other modules on automotive CAN bus 228.

Transmission control module 214 may function in a similar manner as engine control module 212 to control the transmission of vehicle 100 to maintain or transition to a calculated gear or transmission ratio. Instrument cluster control module 216 may similarly function to control various instruments or instrument displays of vehicle 100, such as a speedometer, tachometer, oil pressure gauge, battery charge level indicator, a tire pressure indicator. Security system control module 218 may control a security and/or alarm system associated with vehicle 100 by monitoring signals from door sensors, shock sensors, door lock sensors, window sensors, and/or other security sensors associated with vehicle 100. Antilock braking control module 220 may control a braking system associated with vehicle 100 by monitoring signals from a groundspeed sensor, wheel sleep sensors, brake line pressure sensors, and/or other sensors associated with vehicle 100. Climate control module 222 may control vehicle heating, ventilation, air conditioning, and/or cooling systems by monitoring signals from temperature sensors, humidity sensors, and/or other security sensors associated with vehicle 100. Airbag system control module 224 may control an airbag deployment system associated with vehicle 100 by monitoring signals vehicle speed sensors, impact sensors, and/or sensors associated with vehicle 100. And ride control module 226 may control a suspension and/or traction system associated with vehicle 100 by monitoring signals from vehicle speed sensors, wheel slip sensors, operator input devices, suspension pressure sensors, and/or any other sensors associated with vehicle 100.

Automotive CAN bus 228 may embody any type of CAN bus known in the art. Automotive CAN bus 228 may be configured to enable communication among modules 212-226 using Society of Automotive Engineers (SAE) J1708, SAE J1939, SAE J2411, International Organization for Standardization (ISO) 11898, ISO 11992, ISO 11783, or any other CAN-bus communications protocol known in the art.

Continuing with FIG. 2, electronics architecture CAN bus platform 204 may include systems onboard vehicle 100 configured to perform mission-related functions of vehicle 100. For example, electronics architecture CAN bus platform 204 may include a power management control module 230, a battery health control module 232, a battery charger control module 232, a stability system control module 236, a collision avoidance control module 238, and/or a blind spot detection module 240 interconnected via an electronics architecture CAN bus 242. One of ordinary skill in the art will appreciate, however, that electronics architecture CAN bus platform 204 may include additional and/or different modules for controlling mission-related functions of vehicle 100 other than the examples illustrated in FIG. 2, depending on the vehicle configuration.

Similar to the modules of automotive CAN bus platform 202, modules 230-240 may each include an electronic control unit (ECU), such as an application-specific integrated circuit (ASIC), a field-programmable gate array (FPGA), or another type of integrated circuit or computer processing device executing specialized software or computer program instructions. Modules 230-240 may be configured to monitor and/or control respective onboard systems that perform certain mission-related functions associated with vehicle 100.

Power management control module 230 may be configured to control the electrical power supplied to the onboard systems based on instructions received from VIT 260 and/or on signals provided by vehicle sensors. For example, each onboard system may be assigned to a particular power “channel” or circuit that couples electrical power from the vehicle battery to the onboard system. For example, a vision system 250 of vehicle 100 may be on a first power channel, a laser range finder or other effects system(s) may be on a second power channel, a navigation system 252 may be on a third power channel, and so on. In some configurations, systems may be assigned to specific power channels based on mission criticality. In other configurations, however, several or all of the onboard systems may be assigned to the same power channel.

Power management control module 230 may be configured to toggle on and off the power supplied to a particular channel based on a variety of criteria. For example, as discussed in further detail below, power management control module 230 may switch on or off the power to a particular channel in response to a command received from an operator VIT 260. Power management control module 230 may also switch on or off the power to a particular channel in response to a failure or diagnostic alert associated with an onboard system on that power channel. Further, power management control module 230 may switch on or off the power to a particular channel based on battery charge and/or health metrics indicated by battery health control module 232. For example, if battery health module 232 indicates that the battery health is poor or the charge level is low (e.g., 20%), power management control module 230 may toggle off the power to a particular channel. Still further, power management control module 230 may toggle on or off the power to a particular channel based on predetermined settings or on settings defined by an operator of VIT 260. For example, each power channel may have a predetermined or operator-defined priority relative to the other channels (e.g., based on mission criticality), and power management control module 230 may selectively toggle on or off the power to the channels based on their respective priorities and on the current battery health and/or charge level. As an example, a critical onboard system, such as the laser range finder or other effects system, may be assigned a higher priority than a non-critical system, such as the climate control system. Power management control module 230 may also perform circuit-protection functions. For example, power management control module 230 may monitor the current load and/or temperature of each channel, and may toggle the power off when the current and/or temperature exceed a threshold. Alternatively, power management control module 230 may limit the current in the channel and/or the temperature to the threshold.

Battery health control module 232 may be configured to monitor the health of the battery associated with the vehicle 100. For example, battery health control module 232 may monitor signals received from one or more voltage and/or current sensors associated with the battery. Based on the signals, battery health control module 232 may determine the charge level (e.g., 0%-100%) and/or health (e.g., poor-excellent) of the battery. Battery health control module 232 may then output one or more messages on electronics architecture CAN bus 242 indicative of the determined battery charge level and/or health.

Battery charger control module 234 may be configured to charge the battery of vehicle 100. For example, battery charger control module 234 may be configured to charge the battery with electrical power received from an alternator and/or power inverter associated with vehicle 100, as needed, based on the battery charge level and/or health indicated by battery health control module 232.

Stability system control module 236 may be configured to determine the stability of vehicle 100 based on signals provided by one or more vehicle sensors. For example, based on signals from an inclination sensor indicating the pitch and/or roll of vehicle 100, and on a signal from a speed sensor indicating the speed of travel of vehicle 100, stability system control module 236 may determine a rollover risk of vehicle 100 (e.g., low, medium, or high). If the rollover risk reaches a threshold, stability system control module 236 may provide a visual and/or audible warning to the vehicle operator, such as via an associated warning lamp and/or speaker of vehicle 100. In addition, stability system control module 236 may output a signal on electronics architecture CAN bus 242 indicative of the determined rollover risk and/or of the rollover warning itself.

Collision avoidance control module 238 may be configured to determine a risk of collision of vehicle 100 based on signals provided by one or more vehicle sensors. For example, vehicle 100 may be equipped with one or more sensors configured to determine the range and direction to objects around vehicle 100, such as a camera device, a radar device, a Light Detection and Ranging (LIDAR) device, and/or another device configured to determine a range and direction to objects. Based on signals received from such sensors, in addition to signals received from vehicle sensors or systems indicative of the speed and/or heading of vehicle 100, collision avoidance control module 238 may determine a risk of vehicle 100 colliding with the object (e.g., low, medium, and high). Alternatively, collision avoidance control module 238 may periodically receive signals indicating the position, speed, and/or heading of vehicles in the area, such INS data associated with the vehicles via satellite signals and/or beacons from the vehicles. If the risk of collision reaches a threshold, for example, collision avoidance control module 238 may provide a visual and/or audible warning to the vehicle operator, such as via an associated warning lamp and/or speaker of vehicle 100. Moreover, collision avoidance control module 238 may output a signal on electronics architecture CAN bus 242 indicative of the determined risk of collision.

Blind spot detection control module 240 may be configured to determine when an object—such as another vehicle, a human being, or terrain—is located in or near one or more “blind spots” of vehicle 100. For example, vehicle 100 may be equipped with one or more sensors configured to determine the presence or absence of objects in or near the blind spots of vehicle 100. The sensors may include, for example, motion detectors and/or one or more of the types sensors noted above with respect to collision avoidance control module 238. If an object is determined to be present in a blind spot based on signals received from the sensors, blind spot detection control module 240 may provide a visual and/or audible warning to the vehicle operator, such as via an associate warning lamp and/or speaker of vehicle 100. In addition, blind spot detection control module 240 may output a signal on electronics architecture CAN bus 242 indicative of the presence of the object in the blind spot.

Similar to automotive CAN bus 228, electronics architecture CAN bus 242 may embody any type of CAN bus known in the art. For example, electronics architecture CAN bus 242 may be configured to enable communication among modules 230-240 using SAE 1708, SAE J1939, SAE J2411, ISO 11898, ISO 11992, ISO 11783, or any other CAN-bus communications protocol known in the art.

Continuing with FIG. 2, effects CAN bus platform 206 may include systems onboard vehicle 100 configured to perform, monitor, and/or control various effects-related functions of vehicle 100. For example, effects CAN bus platform 206 may include an effects monitoring control module 244 and/or a projectile detection control module 246 interconnected via an effects CAN bus 248. One of ordinary skill in the art will appreciate, however, that effects CAN bus platform 206 may include additional and/or different modules for controlling or monitoring effects-related functions of vehicle 100 other than the examples illustrated in FIG. 2, depending on the vehicle configuration.

Similar to the modules of automotive CAN bus platform 202 and electronics architecture CAN bus platform 204, modules 244, 246 may each include an electronic control unit (ECU)—such as an application-specific integrated circuit (ASIC), a field-programmable gate array (FPGA), or another type of integrated circuit or computer processing device—executing specialized effects software or computer program instructions. Modules 242, 246 may be configured to monitor and/or control the operations of respective onboard effects systems of vehicle 100.

For example, effects monitoring control module 244 may be associated with effects system 102, which may include a Long Range Acoustic Device, an engine immobilizer, an x-ray interrogation system, or any other type of vehicular-based energy transmission or effects system known in the art. Effects monitoring control module 244 may include or otherwise be associated with one or more effects sensors configured to sense various operational parameters of effects system 102. For example, the sensors may generate signals indicative of the direction in which the effects system is aimed, whether the effects system is engaged, the energy being expended, remaining resources, positional information regarding the target of interest, and/or other metrics relating to operation of effects system 102. Effects monitoring module 244, in turn, may broadcast messages on effects CAN bus 248 indicative of the parameters sensed by the various effects sensors.

Projectile detection control module 246 may be associated with a vehicle-mounted projectile detection system, such as an acoustic gunfire detection system, an infrared sensor-based gunfire detection system, or any other type of projectile detection system known in the art. The projectile detection system may include various sensors—such as microphones, piezoelectric devices, optical sensors, and/or other types of transducers—configured to generate signals of acoustical, optical, or other properties of gunfire or other projectiles in the vicinity of vehicle 100. Based on the signals, projectile detection control module 246 may determine a range from vehicle 100 to the source of the projectiles, a direction to the source with respect to the heading of vehicle 100, and/or other information regarding the projectiles. In addition, projectile detection control module 246 may broadcast messages on effects CAN bus 248 communicating the determined information regarding the projectiles.

Continuing with FIG. 2, serial bus platform 208 may include systems onboard vehicle 100 and configured to perform various mission-support functions. In one embodiment, serial bus platform 208 may include one or more “legacy” systems with which vehicle 100 (e.g., a protected vehicle) is traditionally equipped. For example, serial bus platform 208 may include a vision system 250; an Inertial Navigation System (INS) 252, including or otherwise associated with a Global Positioning System (GPS) 254; a radio system 256; and/or a digital video recording system 258. In certain embodiments, systems 250-258 may be configured to communicate according to Recommended Standard (RS) 232, RS-423, RS-485, and/or any other serial binary communication protocol known in the art.

Vision system 250 may include one or more vision devices mounted on vehicle 100 and configured to gather video data from one or more perspectives around vehicle 100. For example, vision system 250 may include one or more night-vision and/or infrared digital camera devices for enhancing driver and/or passenger vision. Vision system 250 may further include one or more digital camera devices positioned on top of vehicle to provide the driver and/or passengers with a 360-degree view around vehicle 100, such as several wide-angle or fisheye camera devices. Vision system 250 may further include one or more camera devices positioned face to the front, rear, left, and/or right of vehicle 100. In some embodiments, the camera devices may have associated operator interfaces on vehicle allowing occupants to pan, tilt, zoom, or otherwise manipulate the views provided by the cameras. The video data of the camera devices of vision system 250 may be output via video output ports associated with the camera devices. In addition, the camera devices of vision system 250 may output status information, such as whether the camera device is recording, paused, stopped, or has failed—via serial ports associated with the camera devices.

INS 252 may embody an inertial navigation system configured to determine the position, orientation, heading and/or speed of vehicle 100 without the need for an external reference. For example, INS 252 may embody a computer configured to determine the position, orientation, heading and/or speed of vehicle 100 based on signals received from associated motion sensors, such as accelerometers and/or gyroscopes. INS 252 may include an operator interface on vehicle 100 for displaying the position, orientation, and/or heading of vehicle 100 on a map. INS 252 may also provide various vehicle routing functions, such as determining a route or path between selected waypoints. In certain embodiments, INS 252 may output signals indicative of the position, orientation, heading and/or speed of vehicle 100 via an associated serial port.

The GPS 254 associated with INS 252 (if any) may embody any Global Navigation Satellite System (GNSS) device configured to determine the position, orientation, heading and/or speed of vehicle 100 based on signals received from satellites. GPS 254 may include an operator interface on vehicle 100 for displaying the position, orientation, and/or heading of vehicle 100 on a map. GPS 254 may also provide various vehicle routing functions, such as determining a route or path between selected waypoints. In certain embodiments, GPS 254 may output signals indicative of the position, orientation, heading and/or speed of vehicle 100 via an associated serial port.

Radio system 256 may include a government radio system, a military radio system, or any other type of vehicle radio system known in the art. For example, radio system 256 may embody a Combat Net Radio (CNR) configured to communicate voice and data using amplitude modulation (AM), frequency modulation (FM), high frequency (HF), satellite communication, and/or any other radio communications protocol known in the art. In certain embodiments, radio system 256 may output status messages via an associated serial port indicative of the volume level of the radio, the communications band and/or channel on which the radio is operating, the frequency to which the radio is tuned, and/or other information regarding the status of the radio.

Digital video recording system 258 may include one or more devices configured to record input video data in a digital format to a magnetic disk drive, flash drive, memory card, and/or any other computer-readable mass storage device. In certain embodiments, digital video recording system 258 may be configured to receive and record the video output of the camera devices of vision system 250 during a mission. For example, digital video recording system 258 may include a digital video recording device for each camera device of vision system 250. Alternatively, digital video recording system 258 may include one digital video recording device having a separate channel for recording the video output of each camera device. Digital video recording system 250 may be configured playback and output the recorded video data as analog and/or digital video via an associated video output port, such as a Video Graphics Adapter (VGA) port, a Digital Visual Interface (DVI) port, an S-Video port, and/or any other type of video output port known in the art. In addition, digital video recording system 258 may be configured to output video status messages via an associated serial port indicating, for example, whether a digital video recording device is recording, playing back, fast-forwarding, rewinding, stopped or paused.

Onboard network platform 210 may include any type of electronic packet-switched network known in the art. In one embodiment, onboard network platform 210 may embody a wired or wireless local area network (LAN) onboard vehicle 100. Onboard network platform 210 may include one or more wired or wireless routers, network switches, and/or any other devices known in the art for communicating on a local network. In certain embodiments, onboard network platform 210 may connect peripherals, such as laptop computers and other computing devices, to VIT 260 for incorporation into vehicle integration system 200.

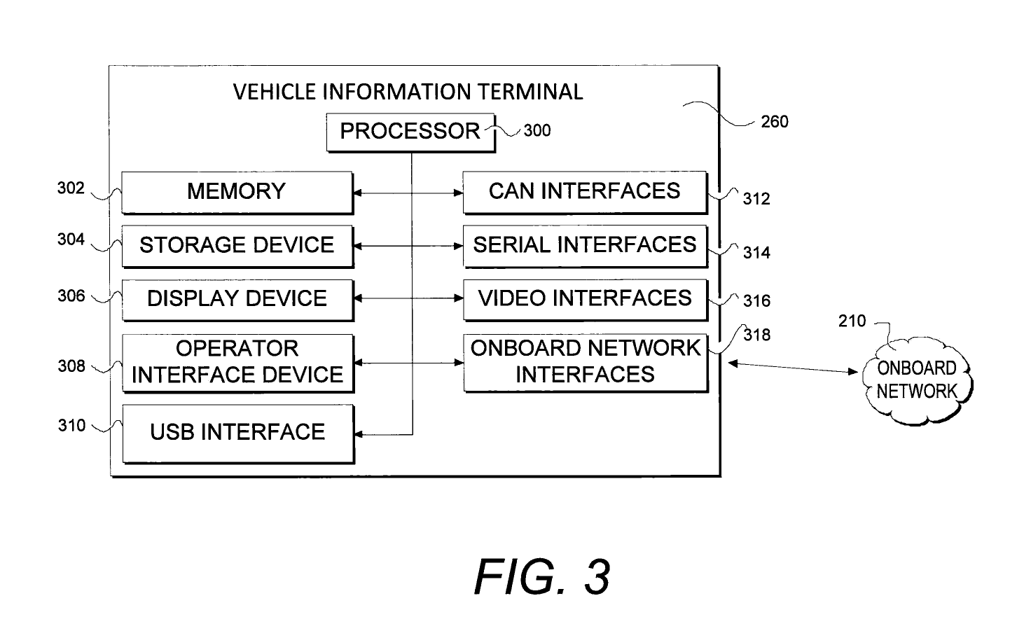

FIG. 3 illustrates a representation of an exemplary configuration of VIT 260. VIT 260 may comprise an onboard vehicle computing device. In one embodiment, VIT 260 may embody a vehicle-mounted display computer configured to run an operating system, such as Windows CE, Linux, or another type of light-weight operating system known in the art. For example, VIT 260 may comprise a CAN-bus display computer made by Grayhill Inc.® or similar type of vehicle-mounted display. In other embodiments, however, VIT 260 may comprise any type of mobile computing device known in the art adapted to interface with multiple platforms, such as a modified smartphone device or the like.

Consistent with the disclosed embodiments, VIT 260 may be configured to execute one or more graphical operator interface (GUI) software applications. As described in greater detail below, the disclosed GUI applications may operate to provide occupants of vehicle 100 with centralized access to the vehicle systems and data. Specifically, the GUI applications may provide interfaces associated with the vehicle systems allowing the occupants access and/or view data output by the onboard systems and their associated sensors, as well as to provide input to control one or more functions of the vehicle systems. It is to be appreciated that system 200 may include a single VIT 260 or multiple VITs 260, depending upon the desired vehicle configuration. In one exemplary embodiment, a VIT 260 may be positioned at or near each passenger station of vehicle 100 in order that each team member aboard vehicle 100 may have convenient and unfettered access to the vehicle systems and data. But in other embodiments VIT 260 may be a single centralized vehicle “hub” computer.

As shown in FIG. 3, VIT 260 may include a computer processor 300 in communication with a memory 302, a storage device 304, a display device 306, a operator interface device 308, a Universal Serial Bus (USB) interface 310, one or more CAN interfaces 312, one or more serial interfaces 314, and/or an onboard network interface 318. It is to be appreciated, however, that VIT 260 may include additional or different computing elements than those illustrated in FIG. 3, depending on the configuration. VIT 260 may interface with directly with vehicle platforms 202-210 via interfaces 310-318 and/or indirectly through an integrated communications “backbone” (not shown) of vehicle 100.

Processor 300 may include any generic or application-specific computer processing device, such as a microprocessor, configured to execute instructions stored in memory 302 to perform the disclosed processes. In one embodiment, processor 300 may include an ARM™ microprocessor, an Intel Core™ processor, or another Reduced Instruction Set (RISC) architecture processor suitable for mobile devices.

Memory 302 may include any combination of random-access memory (RAM) storage devices, read-only memory (ROM) storage devices, or any other type of volatile or non-volatile memory storage devices known in the art.

Display device 306 may include a touch-screen display device, a cathode ray tube (CRT) display device, plasma display device, a liquid crystal display (LCD) device, or any other type of computer display device known in the art.

Operator interface device 308 may include any type of device known in the art for communicating input from a operator to a computing device. For example, operator interface device 308 may include a keypad, a touchpad, a keyboard, a mouse, or a touch-sensitive screen.

USB interface 310 may include any combination of hardware and software configured to interface with USB-complaint peripherals. For example, USB interface 310 may be used to connect a flash memory device storing a software upgrade to VIT 260.

CAN interfaces 312 may include any combination of hardware and software configured to interface and communicate with devices on a CAN bus using any CAN communication protocols known in the art. In one embodiment, CAN interfaces 312 may include a first CAN port for connecting to automotive CAN bus 228, a second CAN port for connecting to electronics architecture CAN bus 242, and a third CAN port for connecting to effects CAN bus 248.

Serial interfaces 314 may include any combination of hardware and software configured to interface and communicate with devices using RS-232, RS-423, RS-485, and/or any other binary serial communication protocol known in the art. In one embodiment, serial interfaces 314 may include serial ports for connecting to the camera devices of vision system 250, to INS 252, to GPS 254, to radio system 256, and/or to digital video recording system 258 to receive status information and/or to communicate operator input commands to these devices.

Video interfaces 316 may include any combination of hardware and software configured to interface with devices to receive digital and/or analog video data. For example, video interfaces 318 may include interfaces configured to process National Television System Committee (NTSC) video streams, Phase Alternating Line (PAL) video streams, and/or any other type of video stream known in the art. In one embodiment, video interfaces 318 may include a separate video port to receive the video output of each camera device of vision system 250 and/or the output of each digital video recording device of digital video recording system 258.

Onboard network interface 318 may include any combination of hardware and/or software configured to communicate on onboard network 210. In one embodiment, network interface 318 may be configured to communicate wirelessly or over wire using Ethernet or another frame-based standard for communicating on local networks.

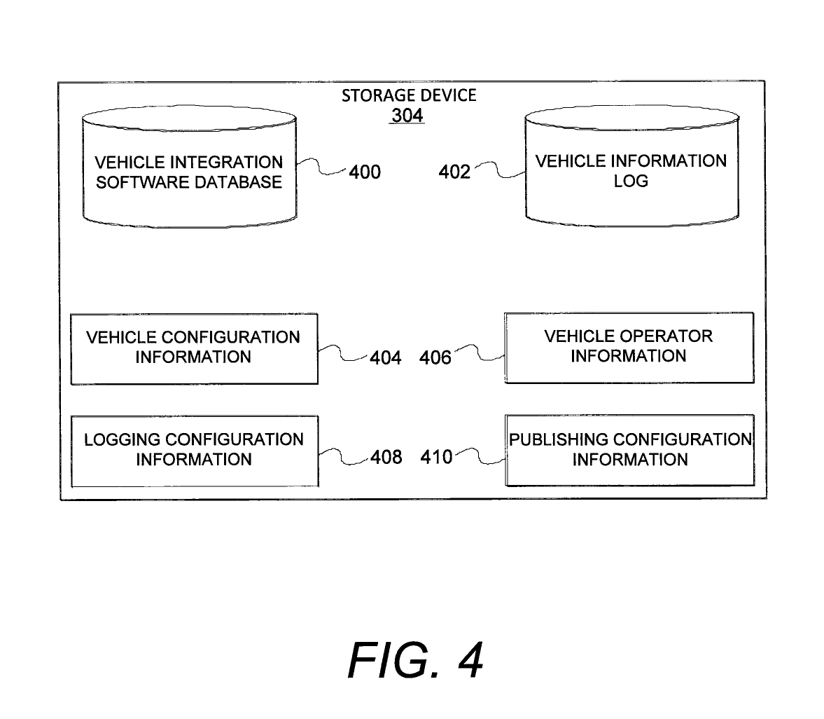

FIG. 4 illustrates a representation of exemplary information stored in storage device 304, consistent with the disclosed embodiments. In one embodiment, storage device 304 may store a vehicle integration software database 400, a vehicle information log 402, vehicle configuration information 404, vehicle operator information 406, logging configuration information 408, and/or publishing configuration information 410.

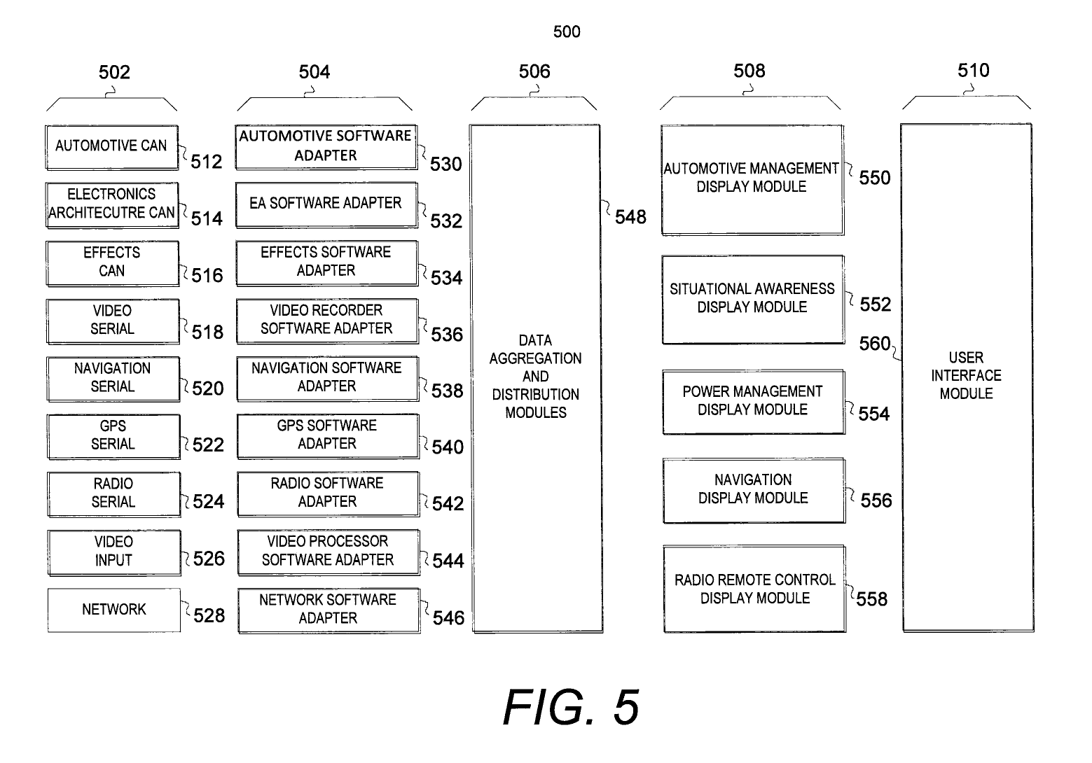

FIG. 5 illustrates a representation of an exemplary vehicle integration software architecture 500 contained in vehicle information software database 400 and executed by VIT 260, consistent with the disclosed embodiments. As shown, vehicle information software architecture 500 may include an interface driver layer 502, a software interface adapter layer 504, an aggregation and distribution layer 506, a graphical operator interface (GUI) application layer 508, and a graphical operator interface (GUI) layer 510. During operation of vehicle 100, processor 300 may load into memory 302 and execute vehicle information software architecture 500 to perform the disclosed processes.

Interface driver layer 502 may comprise software drivers supporting the embedded operating system of VIT 260 and configured to act as an interface to the hardware of onboard platforms 202-210. Interface driver layer 502 may utilize predetermined libraries to translate messages received from onboard platforms 202-210 having a hardware or link-layer format, such as CAN-, serial-, USB- and/or Ethernet-based messages, to messages having formats suitable for software interface adapter layer 504. In addition, interface driver layer 502 may receive messages from software interface adapter layer 504 and translate the messages to formats suitable for communication on vehicle platforms 202-210.

Accordingly, in one embodiment, interface driver layer 502 may include an automotive CAN driver 512. Automotive CAN driver 512 may be configured to translate CAN-based messages received from automotive CAN modules 212-226 on automotive CAN bus 228 into messages having a format suitable for software interface adapter layer 504. Automotive CAN driver 512 may also translate command messages received from software interface adapter layer 504 into a CAN-based format for transmission on automotive CAN bus 228 via CAN interfaces 312. Electronics architecture CAN driver 514 and effects CAN driver 516 may perform similar functions with respect to electronics architecture CAN modules 230-340 on electronics architecture CAN bus 242 and effects CAN modules 244, 246 on effects CAN bus 248, respectively.

Interface driver layer 502 may further include a video serial driver 518. Video serial driver 518 may be configured to translate binary serial-based messages received from one or more of the digital video recording devices of digital video recording system 258 into messages having a format suitable for software interface adapter layer 504. Video serial driver 518 may also be configured to translate command messages received from interface adapter layer 504 into a binary serial-based format, and to transmit the translated command messages to the digital video recording devices via serial interfaces 314. INS driver 520, GPS serial driver 524, and radio serial driver 524 may perform similar functions with respect to INS 252, GPS 254, and radio system 256, respectively.

Continuing with FIG. 5, interface driver layer 502 may also include a video input driver 526. Video input driver 526 may be configured to receive the analog or digital video output of one or more of the camera devices of vision system 250 via video interfaces 316, and to translate the video output into a format suitable for software interface adapter layer 504.

Moreover, interface driver layer 502 may include a network driver 528 configured to receive TCP/IP or other types of packet-based messages from onboard network 210 via onboard network interface 318. In addition, network driver 528 may translate the data to a format suitable for software interface adapter layer 504. Network driver 518 may also receive messages or other data from software interface adapter layer 504, and may translate the data to suitable packet-based messages for communication on onboard network 210.

Software interface adapter layer 504 may include one or more software drivers executing on the embedded operating system of VIT 260. In one embodiment, software interface adapter layer 504 may include a Message-Oriented Middleware (MOM) system configured to implement Advanced Message Queuing Protocol (AMQP) or another messaging protocol to publish, subscribe to, queue, cluster, distribute, or otherwise manage messages transmitted by and/or received at systems operating on different platforms.

As shown in FIG. 5, software interface adapter layer 504 may include an automotive CAN software adapter 530. Automotive CAN software adapter 530 may utilize one or more CAN-bus protocols to subscribe to messages containing sensor data broadcast by automotive control modules 212-226 on automotive CAN bus 228. For example, automotive CAN software adapter 530 may subscribe to vehicle speed, engine speed, oil pressure, engine temperature, fuel level, battery voltage, transmission state, and/or other sensor data broadcast on automotive CAN bus 228. Automotive CAN software adapter 530 may also subscribe to status messages broadcasted on automotive CAN bus 228 by any of automotive control modules 212-226, such as diagnostic messages (e.g., warnings and failures) and/or other messages indicating the operational status of the vehicle systems associated with automotive control modules 212-226. Automotive CAN software adapter 530 may also leverage the CAN bus protocols to translate command messages received from aggregation and distribution layer 506 to a format suitable for automotive CAN driver 512, and to publish the command messages to automotive CAN driver 512 for communication on automotive CAN bus 228.

Software interface adapter layer 504 may further include an electronics architecture CAN software adapter 532. Electronics architecture CAN software adapter 532 may perform similar functions as automotive software adapter 530 with respect to electronics architecture control modules 230-240 on electronics architecture CAN bus 242 and effects control modules 244, 246 on effects CAN bus 248, respectively. For example, electronics architecture CAN software adapter 532 may subscribe to messages broadcast on electronics architecture CAN bus 242 by electronics architecture control modules 230-240 indicating power usage, vehicle health status, battery charge level, battery health, system power consumption, vehicle stability warnings, vehicle collision warnings, blind spot warnings, system failures or warnings, and/or any other information determined and/or monitored by electronics architecture control modules 230-240. Moreover, electronics architecture CAN software adapter 532 may leverage one or more CAN bus protocols to translate command messages received from aggregation and distribution layer 506 to a format suitable for electronics architecture CAN driver 514, and to publish the messages to electronics architecture CAN driver 514 for communication on electronics architecture CAN bus 242.

Similarly, software interface adapter layer 504 may include an effects CAN software adapter 534. Effects CAN software adapter 534 may subscribe to messages on effects CAN bus 248 indicating, for example, the location of sources of hostile threats or projectiles, whether effects system 102 of vehicle 100 is being engaged, an amount of energy expended by the effects system, a direction of the effect, a remaining energy supply, positional information regarding the target of interest, and/or other information monitored or determined by effects CAN control modules 244, 246 and broadcast on effects CAN bus 248. Moreover, effects CAN software adapter 534 may leverage one or more CAN bus protocols to translate command messages received from aggregation and distribution layer 506 to a format suitable for effects CAN driver 516, and to publish the messages to effects CAN driver 516 for communication on effects CAN bus 248.

Software interface adapter layer 504 may further include a video recorder software adapter 536. Video recorder software adapter 536 may utilize one or more binary serial communications protocols to subscribe to status messages broadcast by one or more of the video recording devices of digital video recording system 258 via their associated serial ports. The status messages may indicate, for example, whether the video recording devices are powered on, recording, playing back, stopped, paused, rewinding, fast-forwarding, and/or performing other video operations. In addition, video recorder software adapter 536 may leverage binary serial communications protocols to translate video recorder command messages received from aggregation and distribution layer 506, and to publish the translated commands to video serial driver 518 for communication to digital video recording system 258. Such commands may include, for example, commands to power on/off, play, stop, pause, rewind, and/or fast-forward stored video content of a particular video recording device.

Software interface adapter layer 504 may further include an INS software adapter 538, a GPS software adapter 540, and a radio software adapter 542. Adapters 538-542 may also utilize one or more binary serial communications protocols to subscribe to status messages and/or other information broadcasted by INS 252, GPS 254, and radio system 256, respectively, via their associated serial ports. In the case of INS 252 and/or GPS 254, for example, the broadcast information may include the location, orientation, heading, altitude, latitude, longitude, and/or speed of vehicle 100, and/or any other information relating to the navigation of vehicle 100. In the case of radio system 256, the broadcast information may include the volume level of the radio, the communications band and/or channel on which the radio is operating, the frequency to which the radio is tuned, and/or other information regarding the operational status of radio system 256. In addition, adapters 538-542 may leverage binary serial communications protocols to translate GPS, INS, and/or radio commands received from aggregation and distribution layer 506, and to publish the translated commands to drivers 520-524 for communication to INS 252, GPS 254, and/or radio system 256, respectively. In the case of radio system 256, for example, such commands may include commands to increase or decrease the volume of the radio, to change the communications band and/or channel on which the radio is operating, to change the frequency to which the radio is tuned, to perform a squelch operation, and/or to power the radio on/off.

Software interface adapter layer 504 may further include a video processor software adapter 544. Video processor software adapter 544 may subscribe to the analog and/or digital video output of each vehicle camera device of vision system 250, and/or of each digital video recording device of digital video recording system 258, through video input driver 526. Video processor software adapter 544 may provide the received video to aggregation and distribution layer 506. Moreover, video processor software adapter 544 may receive video processing command messages from aggregation and distribution layer 506. The command messages may include, for example, commands to display, hide, and/or resize a display window associated with the video output of a selected camera device of vision system 250 and/or of a digital video recording device of digital video recording system 258. In response, video processor software adapter 544 may issue corresponding command messages to one or more video processors (not shown) associated with VIT 260 to effect the desired video processing.

Software interface adapter layer 504 may further include a network software adapter 546. Network software adapter 546 may subscribe to messages and commands received from aggregation and distribution layer 506, and may publish the subscribed information to network driver 528 for distribution to onboard network 210. In addition, network software adapter 546 may subscribe to selected messages received from onboard network 210 via network driver 528, for example, based on vehicle configuration or customer preferences, and provide the messages to data aggregation and distribution module 548 for processing.

Aggregation and distribution layer 506 may include a data aggregation and distribution module 548 configured to receive messages from the various adapters of interface adapter layer 504. For example, as discussed above, the messages from interface adapter layer 504 may contain sensor data and/or status information associated with the systems of vehicle 100. In addition, the messages from interface adapter layer 504 may include information received from onboard network 210, such as positional information regarding friendly, hostile, and/or neutral forces, and/or other mission-related information.

Consistent with the disclosed embodiments, aggregation and distribution modules 506 may translate the messages into corresponding messages having a common, system-wide data structure for use in vehicle integration system 200, such that the messages may be used seamlessly by other elements of vehicle integration system 200. Adapters are then used to perform functions such as storage into a data management system, display, or distribution to remote elements or systems. Moreover, aggregation and distribution module 548 may then provide the translated messages to GUI application layer 508, in order that the content of the messages (e.g., sensor data and status information) may be displayed to a operator of VIT 260. In addition, aggregation and distribution module 548 may provide or otherwise make the received messages available to other software adapters of interface adapter layer 504, such that other systems of vehicle 100 may have access to the content of the messages. Moreover, aggregation and distribution module 548 may receive command messages from GUI application layer 508 directed to one or more of the onboard systems, such as a command to adjust the volume of radio system 256. Aggregation and distribution module 548 may translate such messages into specific function calls associated with the targeted vehicle system(s), and provide messages containing the function call to software interface adapter layer 504 for commanding the targeted system to perform the requested function.

GUI application layer 508 may comprise one or more GUI applications 550-558 executing on the embedded operating system of VIT 260. In one embodiment, GUI application layer 508 may include an additional platform or operating system executing on the embedded operating system of VIT 260 on which GUI applications 550-558 execute. The additional platform or operating system may include, for example, Nokia's Symbian™ graphical environment, Apple's IOS™ graphical environment, RIM's Blackberry™ graphical environment, Google's Android™ graphical environment, Windows Mobile™, or another type of graphical environment configured to execute on smart phones or other mobile computing devices.

In one embodiment, illustrated in FIG. 5, GUI application layer 508 may include an automotive management GUI application 550 for interfacing with automotive systems of vehicle 100. GUI application layer 508 may also include a situational awareness GUI application 552 for interfacing with systems onboard vehicle 100 to provide occupants with enhanced awareness of the mission environment. GUI application layer 508 may also include a power management GUI application 554 allowing occupants of vehicle 100 to control the power to various vehicle systems. A navigation GUI application 556 may also be provided for allowing occupants of vehicle to interface with navigation system 252 and/or GPS 254. A radio remote control GUI application 558 may also be provided for allowing occupants of vehicle 100 to remotely interface with and control radio system 256. It is to be appreciated that GUI application layer 508 may include additional and/or different types of GUI applications for interfacing with the systems of vehicle 100, depending on the configuration of vehicle 100, the requirements of customers, and/or other factors. In one embodiment, GUI applications 550-558 may include Qt Meta-Object Language (QML) applications developed using Nokia's Qt™ GUI application framework and defining the UI elements, layout, configuration, and functionality of the operator interlaces of applications 550-558. In addition, GUI applications 550-558 may be enhanced with C++™, Java™, and/or another high-level programming language to enable GUI applications 550-558 to interface with and control the onboard systems of platforms 202-208.

Consistent with the disclosed embodiments, GUI applications 550-558 may include one or more application objects defining UI elements for displaying sensor data, status information, control information, and/or other information broadcasted on automotive CAN bus 228, electronics architecture CAN bus 242, effects CAN bus 248, serial platform 208, and/or onboard network 210. For example, an object corresponding to a speedometer UI element may identify graphics and/or animation logic for a virtual speedometer and a unique CAN node or data ID associated with the vehicle speed data broadcast on automotive CAN bus 228. Similarly, an application object corresponding to a check-engine UI element may identify graphics and/or animation logic for a virtual check engine lamp and a CAN node or data ID associated with the check engine status broadcast on automotive CAN bus 228.

In addition, GUI applications 550-558 may include one or more application objects corresponding to control UI elements for systems on automotive CAN bus 228, electronics architecture CAN bus 242, effects CAN bus 248, serial platform 208, and/or onboard network 210. For example, an object corresponding to a radio volume control UI element may identify graphics and/or animation logic for a virtual radio volume knob and binary serial commands for controlling radio system 256 to increase/decrease the volume. An application object corresponding to a power management UI element for a camera device of vision system 250 may identify graphics and/or animation logic for a virtual power button for the camera, a node ID corresponding to power management control module 230 on electronics architecture CAN bus 242, a power channel ID associated with the camera, and a power on/off command to power management control module 230. It is to be appreciated that GUI applications 550-558 may include additional and/or different application objects for defining UI elements corresponding to any other sensors, output data, and/or control interfaces for systems associated with vehicle 100.

Graphical operator interface (GUI) layer 510 may include a GUI module 560 configured to provide a human interface between display device 306 and UI elements of GUI applications 550-558. For example, GUI module 560 may associate regions of display device 306 with corresponding UI elements such that tactile input to the regions received from an operator of VIT 206 causes activation of the UI elements of GUI applications 550-558.

Returning to FIG. 4, vehicle information log 402 may contain certain sensor data, system status information, and/or other information broadcast on any of platforms 202-210 and gathered by VIT 260 for storage. In certain embodiments, the information stored in vehicle information log 402 may be geo-located according to information received from INS 252 and/or GPS 254. Alternatively, the stored information may be correlated according to other desired criteria. The stored information may also be stored using the common data structure for use on vehicle integration system 200.

Vehicle configuration information 404 may include information identifying the configuration of vehicle 100. For example, configuration information 404 may include a vehicle identification number (VIN), a vehicle platform ID, an identification of onboard systems and/or platforms 202-210 with which vehicle 100 is equipped, and an identification of a software version and/or GUI applications installed on VIT 260, and/or other information relating to the configuration of vehicle 100.

Vehicle operator information 406 may contain information about operators of VIT 260. It is to be appreciated that operators of VIT 260 may have different authorization levels, rankings, positions, roles, and/or mission assignments. Thus, an operator may have unique requirements or preferences regarding which GUI applications 550-558 and/or vehicle systems are relevant depending upon the operator's role on the team. For example, the driver of vehicle 100 may require or prefer access only to automotive management GUI application 550 and/or navigation GUI application 556 to view information relevant to navigating vehicle 100. A commander of vehicle 100, on the other hand, may require or prefer access to situational awareness GUI application 552 to assist in identifying potential threats around vehicle 100. The weapons officer may also require or prefer access to power management GUI application 554 to allocate battery power among the systems of vehicle 100 efficiently during a mission. In addition, the commander may require or prefer use of radio remote control GUI application 558 in order to coordinate with cooperating forces or teams. Accordingly, in one embodiment vehicle operator information 406 may identify authorized operators of VIT 260 and associate the operators with predetermined GUI applications of VIT 260 relevant to their roles or functions on a team. In other configurations, vehicle operator information 406 may associate a operator of VIT 260 with one or more GUI applications based on the operator's preferences.

Logging configuration information 408 may contain instructions for logging of the sensor data, status information, and/or other data broadcasted on vehicle platforms 202-210 in vehicle information log 402 during operation of vehicle 100. Logging configuration information 1408 may be based on the vehicle configuration, customer requirements, preferences set by an operator of VIT 260 and/or other factors.

For example, in one embodiment, logging configuration information 408 may indicate that VIT 260 is to periodically log vehicle speed, engine speed, and/or automotive diagnostic information broadcast by automotive modules 212-226 on automotive CAN bus 228. Logging configuration information 408 may further indicate that VIT 260 is to log vehicle heading, orientation, altitude, latitude, and longitude broadcast by GPS 254 and/or INS 252 on serial platform 208. Logging configuration information 408 may further indicate that VIT 260 is to log battery charge level and health, vehicle collision warnings, vehicle stability warnings, and/or device power status broadcast by electronics architecture control modules 230-240 on electronics architecture CAN bus 242. Still further, logging configuration information 408 may indicate that VIT 260 is to log information regarding the locations of sources of threats, an indication of whether effects system 102 is being engaged, an amount energy or resources being expended, the remaining resources of effects system 102, and positional information regarding the target of interest broadcast by effects monitoring control modules 244, 246 on effects CAN bus 248. It is to be appreciated, however, that other logging configurations are possible. In some embodiments, logging configuration information 408 may also indicate a manner in which the logged data is to be correlated or fused, such as by geo-location, time, and/or other criteria.

Publishing configuration information 410 may contain instructions for publishing the sensor data, status information, and/or other data associated with the systems of vehicle 100 to onboard network 210 during operation of vehicle 100. Similar to logging configuration information 408, publishing configuration information 410 may be based on the vehicle configuration, customer requirements, preferences set by an operator of VIT 260, and/or other factors. For example, in one embodiment, publishing configuration information 410 may indicate that VIT 260 is to periodically or continuously (e.g., in real-time) publish to onboard network 210 vehicle speed, location, heading, battery charge level and health, locations of any potential threats, vehicle collision warnings, vehicle stability warnings, and/or any other information broadcast on platforms 202-210. In this manner, other entities aboard vehicle 100 may access the published data over on-board network 210 and thereby understand or appreciate the environment in which vehicle 100 is operating. For example, a passenger of vehicle 100 may connect a laptop computer or other computing device to onboard network interface 318 (e.g., via Ethernet) and view a “webpage” of GPS or navigation data, webpage of automotive data, a webpage of effects- or mission-related data, and/or a webpage containing other vehicle information. In addition, applications may be provided on the laptop computer to interface with the vehicle systems on vehicle platforms 202-210. It is to be appreciated that other configurations for publishing data to onboard network 210 are possible.

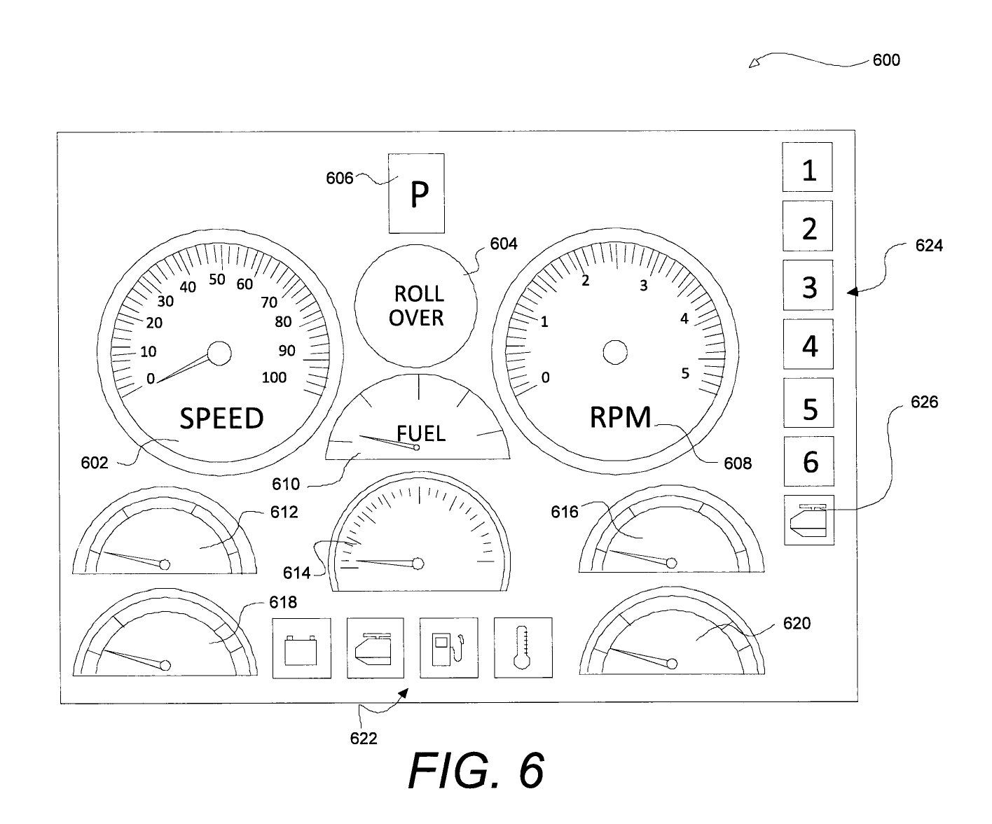

FIG. 6 shows an exemplary representation of an automotive instrument display window 600 associated with automotive management GUI application module 550, as displayed on display device 306 to a operator of VIT 260. As illustrated, window 600 may include a speedometer UI element 602, a rollover indicator UI element 604, a transmission state indicator UI element 606, a tachometer UI element 608, a fuel level indicator UI element 610, an engine temperature indicator UI element 612, a turbocharger boost indicator UI element 614, a transmission temperature indicator UI element 616, a battery voltage indicator UI element 618, an oil pressure indicator UI element 620, and one or more diagnostic alert UI elements 622.

Speedometer UI element 602 may indicate the speed of vehicle 100. Specifically, as discussed above, vehicle speed sensor data may be broadcast as a message on automotive CAN bus 228 by engine control module 212 and/or instrument cluster control module 216. The vehicle speed message may be communicated through vehicle information software architecture 500, as described above, and received at automotive management GUI application 550. Then, an application object corresponding to speedometer UI element 602 may interpret the speed data based on the unique CAN node ID and/or data ID associated with the speed data, and may animate speedometer UI element 602 to reflect the speed of vehicle 100. Similar operations may be performed with respect to rollover indicator UI element 604, transmission state indicator UI element 606, tachometer UI element 608, fuel level indicator UI element 610, engine temperature indicator UI element 612, turbocharger boost indicator UI element 614, transmission temperature indicator UI element 616, battery voltage indicator UI element 618, oil pressure indicator UI element 620, and diagnostic alert UI elements 622 with respect to the display of their associated sensor and/or status data.

As shown, window 600 may further include one or more view selector UI elements 624. In one embodiment, view selector UI elements 624 may operate as “presets” allowing the operator of VIT 260 to select different views of UI elements 602-622. For example, the embodiment illustrated in FIG. 6 may correspond to a first view of UI elements 602-622 displayed when the operator provides tactile input to display device 306, or via an associated peripheral device, to select view selector UI element “1”. Operator input to view selector UI elements “2”-“6” may cause window 600 to display additional views of UI elements 602-622. The additional views may include, for example, UI elements 602-622 corresponding to different combinations of automotive sensors and/or status indicators. The additional views may also display UI elements 602-622 with different graphical themes or animations, such as a digital instrument display rather than an analog instrument display. Moreover, selection of a diagnostic view UI element 626 may cause window 600 to display additional information 700 about any automotive diagnostic messages associated with diagnostic alert UI elements 622, as shown in FIG. 7.

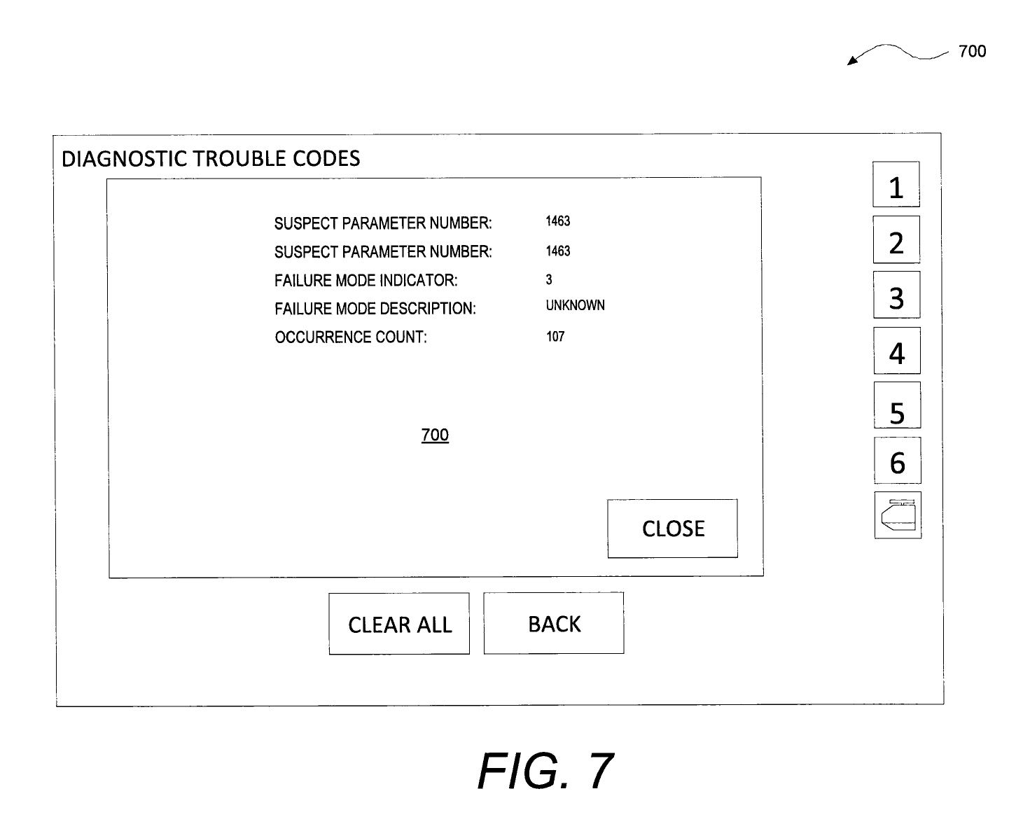

FIG. 8 shows an exemplary representation of a situational awareness display window 800 associated with situational awareness GUI application 552, as displayed on display device 306 to an operator of VIT 260. In the exemplary configuration illustrated, window 800 includes a first video UI element 802, a second video UI element 804, and a video UI element 806.

In one embodiment, video UI elements 802-806 may display video output from respective camera devices associated with vision system 250 and/or respective digital video recorders associated with digital video recording system 258. For example, video UI element 802 may display video output by a camera device of vision system 250 mounted above vehicle 100 and/or video output by a digital video recording device of digital video recording system 158 that records the video data output by that camera device. Video UI element 804 may display video output by a night-vision or infrared camera device of vision system 250 and/or video output by a digital video recording device of digital video recording system 258 that records the video data output by that camera device. Finally, video UI element 806 may display video output by a camera device of vision system 250 mounted at the rear of vehicle 100 and/or video output by a digital video recording device of digital video recording system 258 that records the video data output by that camera device.

Situational awareness display window 800 may allow a operator of vehicle integration terminal to provide input to operator interface device 310, such as tactile input to the display of VIT 260, to move, resize, show, hide, and/or to perform other video processing functions on the video output of video UI elements 802-806. In response to such input, an application object of situational awareness GUI application 552 associated with the selected video UI element 802-806 may generate a corresponding command message. The command message may be, for example, a text message containing an identification of the camera device associated with the selected video UI element 802 and a binary, serial-based command instructing the requested video processing function (e.g., move, resize, show, and/or hide the video). As described above, the message may be received at data aggregation and distribution module 548 and communicated through vehicle information software architecture 500 to video processor software adapter 544, which may instruct the video processor associated with the camera to perform the requested function.

In addition, situational awareness display window 800 may include one or more view selector UI elements 808. In one embodiment, view selector UI elements 808 may operate as “presets” allowing the operator of VIT 260 to select different views of video UI elements 802-806. The additional views may include, for example, video UI elements 802-806 having different display arrangements and/or displaying the video output of different combinations of camera devices associated with vision system 250 and/or of digital video recorders associated with digital video recording system 258.

Situational awareness display window 800 may also include video control UI elements 810 allowing to operator to play, rewind, fast-forward, pause, and/or stop playback of the video displayed via video UI elements 802-806. For example, the operator may have selected video UI element 802, and may then select the “rewind” video control UI element 810. In response, an application object of situational awareness GUI application 552 associated with the selected rewind UI element 810 may generate a corresponding rewind command message. The rewind command message may be, for example, a text message containing a rewind command and an identification of the digital video recording device of digital video recording system 258 associated with video UI element 802 (in this case, the recording device recording the video output of the camera mounted on top of vehicle 100). As described above, the command message may be received at data aggregation and distribution module 548, which may notify any subscribing interfaces—in this case, video recorder software adapter 536—that the rewind command has been issued by making the message available for processing. Video recorder software adapter 536 may then generate a binary serial rewind command message based on known information regarding binary serial communications protocols and on known configuration information regarding the digital video recording device. Video recorder software adapter 536 may then publish the message to video serial driver 518 to instruct the video recording device to perform the rewind command. Similar operations may be performed with respect to the other video control UI elements 808 to perform their respective functions.

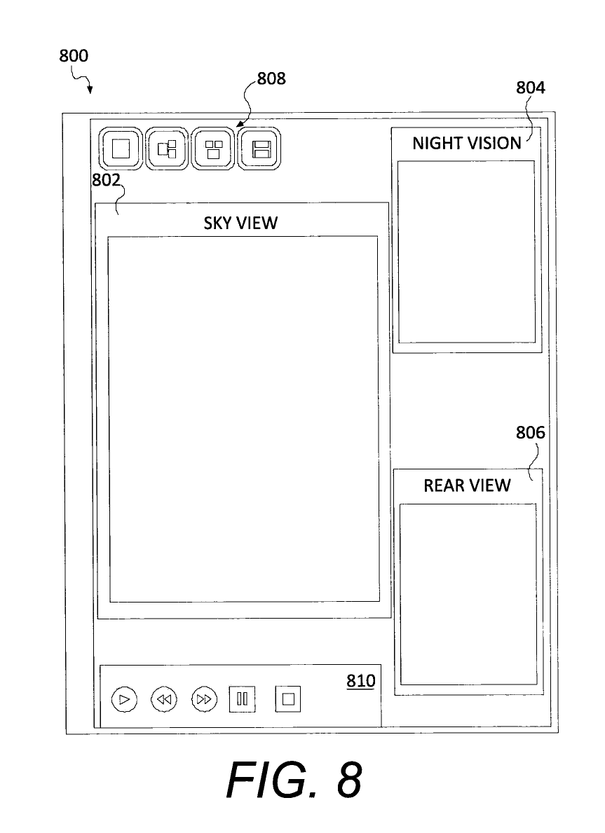

FIG. 9 shows an exemplary representation of a power management control window 900 associated with power management GUI application 554, as displayed on display device 306 to a operator of VIT 260. In the exemplary configuration illustrated, window 900 includes a mission computer power control UI element 902 allowing the operator to toggle on/off the power to vehicle mission computer, a vision system power control UI element 904 allowing the operator to toggle on/off the power to one or more camera devices of vision system 250, a radio power control UI element 906 allowing the operator toggle on/off the power to radio system 256, a stability system power control UI element 908 allowing the operator to toggle on/off the power to the stability system of vehicle 100, a effects system power control UI element 910 allowing the operator to toggle on/off the power to effects system 102, and/or a Navigation System power control UI element 912 allowing the operator to toggle on/off the power to the INS 252 and/or GPS 254. But it is to be appreciated that window 900 may include additional and/or different elements for toggling power to other systems onboard vehicle 100.

As an example, when the operator selects vision system power control UI element 904, an application object of power management GUI application 556 associated with UI element 904 may generate a corresponding power on/off command message. The power on/off command message may be, for example, a text message containing a power on/off command and an identification of one or more camera devices of vision system 250. The command message may be received at data aggregation and distribution module 548, which may notify any subscribing interfaces—in this case, electronics architecture CAN software adapter 532—that the power on/off command has been issued by making the command message available. Electronics architecture CAN software adapter 532 may then generate a CAN-based command message including an identification of the one or more camera devices associated with vision system 250 to be powered on/off, a node ID on electronics architecture CAN bus 242 associated with power management control module 230, and a power on/off command. Adapter 532 may then publish the command message to electronics architecture CAN driver 514, which may broadcast the message on electronics architecture, CAN bus 242 to command power management control module 230 to power on/off the power channel associated with the identified camera device(s) of vision system 250. Similar operations may be performed with respect to the other power control UI elements 902-912 to power on/off their associated onboard systems of vehicle 100.

In some embodiments, power management GUI application 554 may visually distinguish power control UI elements 902-912 based on the power status of their associated devices and or systems. For example, if vision system 250 is powered on, off, or has failed, power control UI element 904 may be respectively highlighted or colored in green, gray, or red. The power status messages may be broadcasted on and received from vehicle platforms 202-210 and reflected by power control UI elements 902-913 in a similar manner as discussed above in connection with the sensor data indicated by automotive UI elements 602-622.

Window 900 may further include a battery charge UI element 914 and a battery health UI element 916 indicating respectively the charge level and health of the vehicle's battery. The battery charge and health information may be received from battery health control module 232 and/or battery charger control module 232 and indicated by UI elements 914 and 916 in a similar manner as discussed above in connection with the sensor and/or status information indicated by other UI elements (e.g., automotive UI elements 602-622). Further, window 900 may include a power configuration UI element 918 allowing the operator to set various power settings for the vehicle systems associated with power control UI elements 902-904. For example, selection of power configuration UI element 918 may allow the operator to set voltage, current, and/or temperature thresholds for the each of the power channels. The set power configuration information may be communicated to power management control module 230 using message commands in a similar manner as discussed above in connection with the command messages associated with other UI elements.

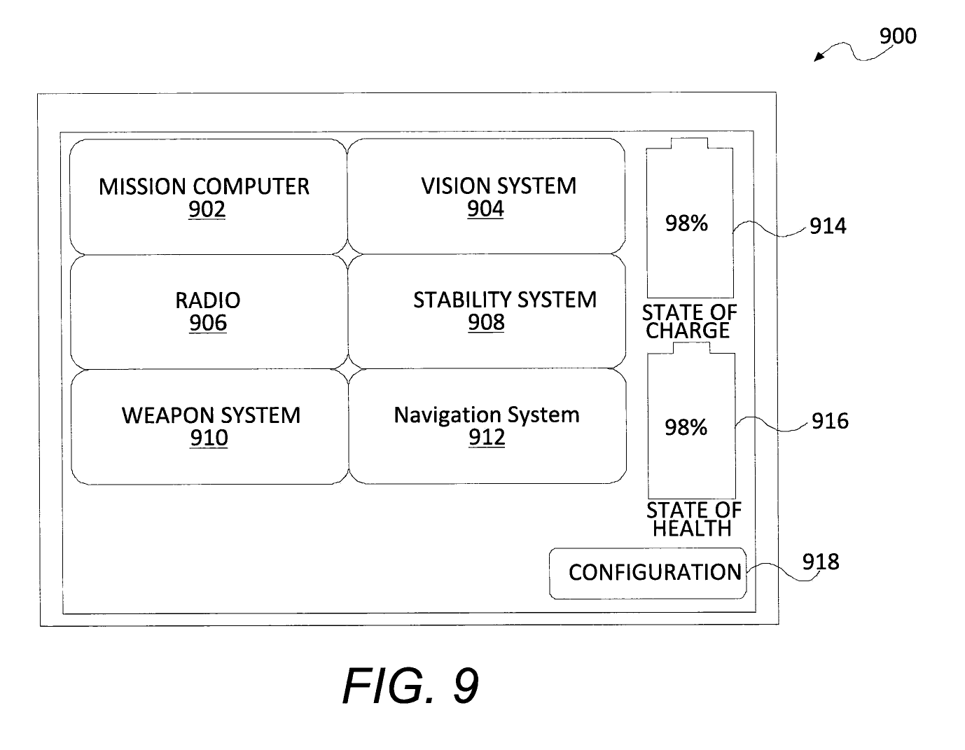

FIG. 10 shows an exemplary representation of a radio control window 1000 associated with remote radio control GUI application 558, as displayed on display device 306 to an operator of VIT 260. Window 1000 may include, among other UI elements for controlling radio system 256, a volume control UI element 1002 and a frequency control UI element 1004. Operator input to volume control UI element 1002 may cause a volume up/down command message to be communicated from VIT 260 to radio system 256 in a similar manner as discussed above in connection with the command messages associated with the other GUI applications and/or UI command elements. Operator input to frequency control UI element 1004 may similar cause a frequency increase/decrease command to be communicated from VIT 260 to radio system 256.

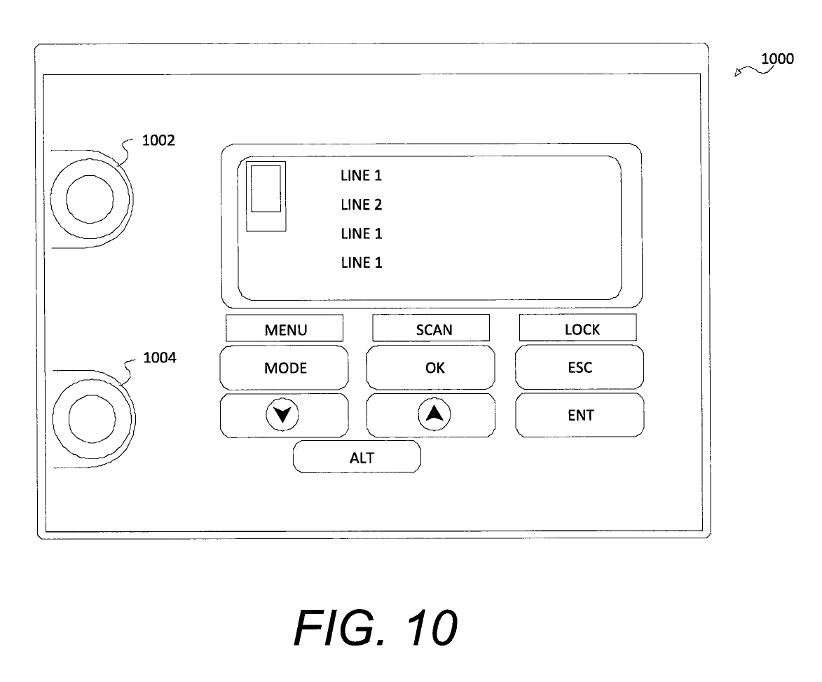

FIG. 11 shows an exemplary representation of a vehicle navigation window 1100 associated with navigation GUI application 556, as displayed on display device 306 to a operator of VIT 260. Window 1100 may include, among other UI elements, a Zulu time GUI element 1202, a ground speed UI element 1204, a vehicle heading UI element 1206, a magnetic declination UI 1208, a latitude UI element 1210, a longitude UI element 1212, an altitude UI element 1214, and a compass UI element 1216.

Navigation GUI application 556 may receive data broadcast by INS 252 and/or GPS 254 on serial platform 208 to display, animate, and/or otherwise modify UI elements 1202-1216. For example, INS 252 may broadcast a message containing the heading of vehicle 100 on serial platform 208, and the message may be received by VIT 260 at one of serial interlaces 314. Radio serial driver 524 may then convert the message for processing by software. Radio serial adapter 524 may subscribe to and receive the message from radio serial driver 524. In addition, using known information regarding serial communications protocols (e.g., RS-232) and known information regarding the configuration of INS 252, navigation serial adapter 520 may convert and publish the message to data aggregation and distribution module 544. Data aggregation and distribution module 548 may then convert the message to the common data format for vehicle integration system 200, and provide the message (e.g., a text message) to navigation GUI application 556. Then, objects of navigation GUI application 556 associated respectively with vehicle heading UI element 1206 and compass UI element 1216 may extract the vehicle heading information from the message and display, animate, and/or otherwise modify UI elements 1206, 1216 to reflect the heading of vehicle 100.

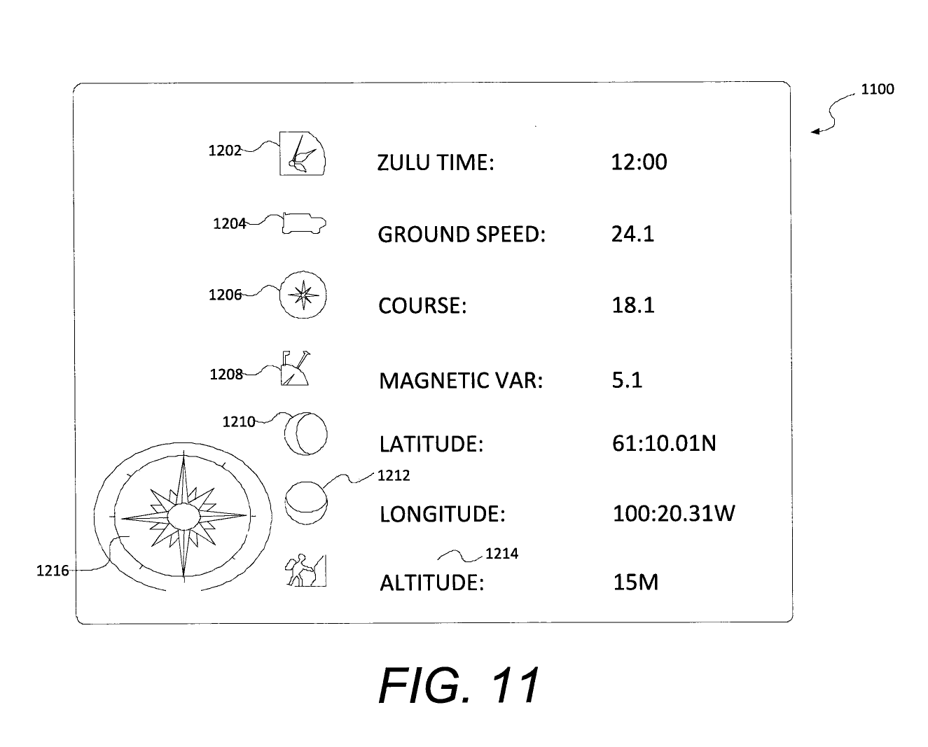

FIG. 12 is flowchart illustrating an exemplary method 1200 performed by VIT 260 for reflecting sensor data and/or status information broadcast by systems of vehicle 100 on platforms 202-210, consistent with the disclosed embodiments. Specifically, method 1200 may be performed by processor 300 executing software architecture 500.

Initially, VIT 260 may identify one or more GUI application installed on VIT 260 based on vehicle configuration information 402 and/or vehicle operator information 404. For example, after VIT 260 is powered on, an operator aboard vehicle 100 may input operator credentials, such as a operator name and/or password, to VIT 260. Based on the received operator credentials, VIT 260 may then identify a role, assignment, position, ranking, and/or other status of the operator based on vehicle operator information 404. VIT 260 may then identify the available GUI applications installed on VIT 260 that correspond to the operator's status based on vehicle configuration information 402. Then, VIT 260 may load or otherwise initialize the identified GUI applications. For example, VIT 260 may display a “home” screen having icons for all the initialized GUI applications and allowing the operator select and launch a desired GUI application.

In step 1202, VIT 260 may receive a message broadcast on one of vehicle platforms 202-210 and containing sensor data and/or status information associated with a system of vehicle 100. For example, VIT 260 may receive a message containing automotive sensor data broadcast by instrument cluster control module 216 on automotive CAN bus 228 or a message containing INS data broadcast by INS 252 on serial platform 208.

In step 1204, VIT 260 may aggregate the message received in step 1202. For example, VIT 260 may convert the message using a driver of interface driver layer 502 corresponding to the system of vehicle 100 from which the message was received (e.g., automotive CAN driver 512 or navigation serial driver 520), as discussed above. VIT 260 may then use a software adapter of software interface adapter layer 504 corresponding to the vehicle system (e.g., automotive CAN software adapter 530 or navigation software adapter 538) to subscribe to the converted message and publish the message to aggregation and distribution layer 506. Data aggregation and distribution module 548 may then translate the message to the common format for vehicle integration system 200.

In step 1206, VIT 260 may provide the message aggregated in step 1204 to the GUI application. For example, data aggregation and distribution module 548 may generate a text message having the common format for vehicle integration system 200 and containing the sensor data and/or status information, and provide the text message to the GUI application associated with the message (e.g., automotive management GUI application 550 or navigation GUI application 556).

In some embodiments, VIT 260 may also in step 1206 notify additional onboard systems of vehicle 100 that the sensor data and/or status information is available. For example, data aggregation and distribution module 548 may additionally transmit the text message to the remaining software adapters of software interface adapter layer 504 associated with the other vehicle systems. Software interface adapter layer 504 may then subsequently publish the message to the other systems of vehicle 100 using the respective software adapters.

In step 1208, VIT 1206 may display the sensor data and/or status information contained in the message using a UI element of the GUI application. For example, as discussed above, an object of the GUI application may extract the sensor data and/or status information and display and/or animate a corresponding UI element corresponding to the extracted information. Continuing with the example above, an object of automotive management GUI application 550 may extract vehicle speed data and may animate speedometer UI element 602 based on the extracted data. Similarly, navigation GUI application 556 may extract vehicle heading data and may display and/or animate heading UI element 1206 and/or compass UI element 1216.

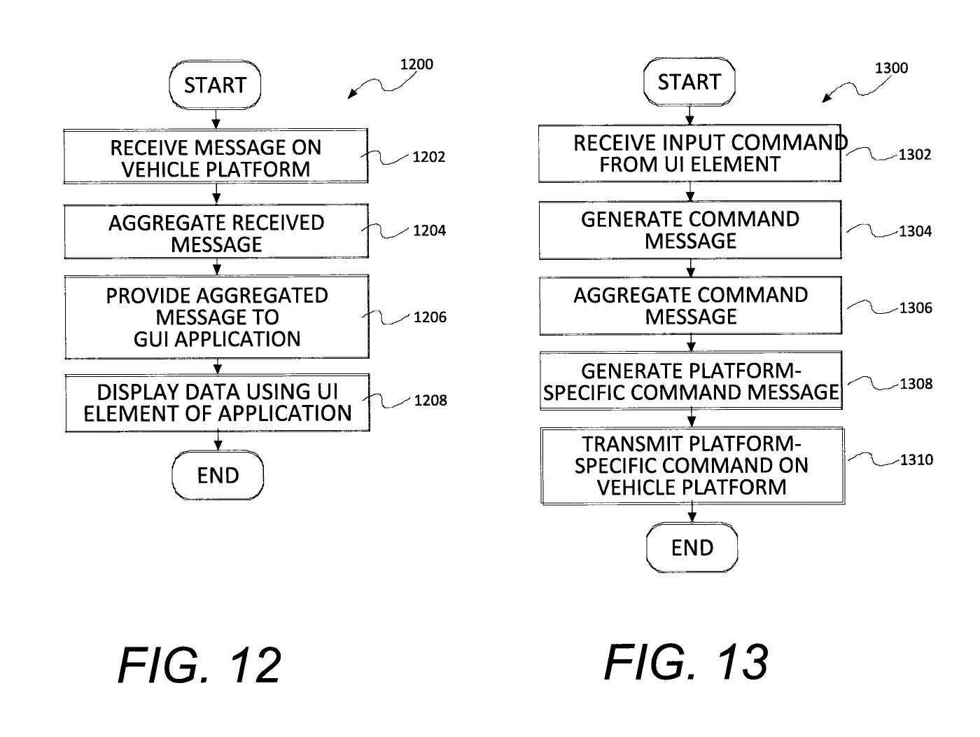

FIG. 13 is a flowchart illustrating an exemplary method 1300 performed by VIT 260 for commanding a system of vehicle 100 based on operator input to a UI element of a GUI application, consistent with the disclosed embodiments. Specifically, method 1200 may be performed by processor 300 executing software architecture 500.

In step 1302, VIT 260 may receive input from a operator to a UI element of a GUI application currently running on VIT 260. For example, a communications specialist aboard vehicle 100 using remote radio control GUI application 558 may provide tactile input to volume control UI element 1002 requesting to increase the volume of radio system 256. Alternatively or additionally, a crew member aboard vehicle 100, using a different VIT 260 and running power management GUI application 554, may provide tactile input to Navigation System power control UI element 912 request cutting power to the channel associated with INS 252.

In step 1304, VIT 260 may generate a corresponding command message based on the operator input received in step 1302. For example, an object of remote radio control GUI application 558 associated with volume control may generate a text message having the common data format of vehicle integration system 200 and containing an identification of radio system 256 (the commanded device) and an instruction to increase the volume of radio system 256. In the case of the INS command, an object of power management GUI application 554 may similarly generate a text message having the common format of vehicle integration system 200 and containing an identification of INS 252.

In step 1306, VIT 260 may aggregate the received command message. For example, data aggregation and distribution module 548 may receive the command messages from the GUI applications. Data aggregation and distribution module 548 may then notify other onboard systems of vehicle 100 that the command messages are available for processing by providing or otherwise making available the command messages to one or more software adapters of interface adapter layer 504. Continuing with the radio example above, data aggregation and distribution module 548 may provide or otherwise make available the volume increase command message to radio software adapter 542. In the case of the INS power command example, data aggregation and distribution module 548 may provide or otherwise make available the command message to electronics architecture CAN software adapter 532.

In step 1308, VIT 260 may generate a platform-specific command message based on the aggregated command message. For example, radio software adapter 542 may subscribe to and receive the message containing the command to increase the volume from data aggregation and distribution module 548. Radio software adapter 542 may then, using known information regarding binary serial communications protocols (e.g., RS-232) and configuration information regarding radio system 256, convert the message to a corresponding binary serial command message appropriate for communication on serial platform 208. Radio software adapter 542 may then publish the message to radio serial driver 524.

In the case of the INS power command, electronics architecture CAN software adapter 532 may convert the command message to a corresponding CAN-based command message appropriate for communication on electronics architecture CAN bus 242, based on information contained in the message and on known information regarding CAN bus communications protocols. Electronics architecture CAN software adapter 532 may then publish the message to navigation serial driver 520.

In step 1310, VIT 260 may transmit the platform-specific command message generated in step 1308 on the appropriate vehicle platform 202-210 in order to command the targeted system of vehicle 100. Specifically, interface driver layer 502 may broadcast the platform-specific message to the vehicle platform 202-210 via a corresponding a corresponding interface 310-318. For example, continuing with the command to increase the volume of radio system 256, radio serial driver 524 may broadcast the serial platform-based command to radio system 256 via the appropriate serial interface 314. In the case of the command to terminate power to INS 252, electronics architecture CAN driver 514 may broadcast the CAN-based command to power management controller 230 on electronics architecture CAN bus 242 via an appropriate CAN interface 312. Radio system 256 and INS 252 may then respond to the respective commands.

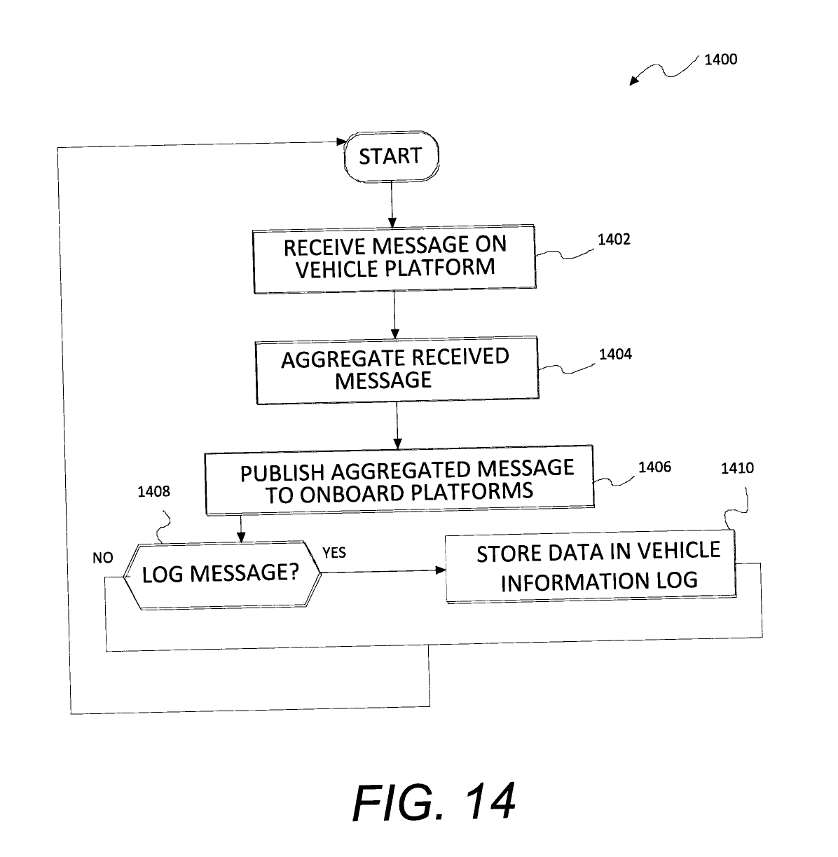

FIG. 14 is flowchart illustrating an exemplary method 1400 performed by VIT 260 for managing information broadcast on vehicle platforms 202-210, consistent with the disclosed embodiments. Specifically, method 1400 may be performed by the processor VIT 260 executing the above-described software architecture.

In step 1402, VIT 260 may receive a message broadcast on vehicle platforms 202-210, such as sensor data, status information, and/or any other information associated with the vehicle systems, as discussed above.

In step 1404, VIT 260 may aggregate the message received in step 1402. For example, VIT 260 may convert the message using a driver of interface driver layer 502 corresponding to the vehicle platform 202-210 from which the message was received (e.g., automotive CAN driver 512 or navigation serial driver 520), as discussed above. VIT 260 may then use a corresponding software adapter of interface adapter layer 504 to subscribe to the converted message and publish the message to the aggregation and distribution layer. Data aggregation and distribution module 548 may then translate the message to the common format for vehicle integration system 200.

In step 1406, VIT 260 may publish the aggregated message to any other onboard platforms 202-210 (other than the platform from which the message was received). For example, data aggregation and distribution module 548 may generate a text message having the common format for vehicle integration system 200 and containing the sensor data and/or status information. Data aggregation and distribution module 548 may then publish the message to the software adapters of interface adapter layer 504 associated with onboard platforms 202-210. For example, INS data received on serial platform 208 and published by navigation software adapter 538 may be published as a message to automotive CAN software adapter 530, electronics architecture software adapter 532, effects software adapter 534, and network software adapter 546. The software adapters may then process the message as described above if the software adapters subscribe to that message (i.e., the INS message). For example, in the case of publishing to onboard network 210, data aggregation and distribution module 248 may provide the message to network software adapter 546. Network software adapter 546, subscribing to the message, may convert the message based on known network communication protocols (e.g., Ethernet) and provide the converted message to network driver 528, which may transmit the message on onboard network 210. Also in step 1406, data aggregation and distribution module 548 may provide the message to any GUI applications running on VIT 260 for processing.

In step 1408, VIT 260 may determine whether to log the message in vehicle information log 402. For example, VIT 260 may access logging configuration information 408 to retrieve the logging instructions associated with vehicle 100. Then, VIT 260 may determine whether to log the published message based on the retrieved logging instructions and on the origin and/or content of the published message.

If it is determined in step 1408 to log the published message, in step 1410, VIT 260 may store the content data of the published message in the vehicle information log 402. Specifically, VIT 260 may extract the content of the message and store the extracted content in an entry in vehicle information log 402. VIT 260 may also geo-locate or otherwise correlate/fuse the entry based on INS data and/or other information, as discussed above.

After completion of step 1410, and/or if it is determined in step 1408 not to log the published message, processing may return to step 1402 to handle any other messages received on onboard platforms 202-210.

In addition, VIT computer 260 may be extended to provide a capability action control UI elements 1502 that manage various capability display modules 550-558 of vehicle 100. Capability action display modules 550-558 may include independent software applications configured to perform various functions associated with different capabilities of vehicle 100. In one embodiment, capability action display modules 550-558 may include a platform health application configured to provide health data associated with vehicle platforms 202-210, an operational readiness application configured to scan vehicle platforms 202-210 to determine whether the systems are functioning properly, a technical data viewer application allowing the operator to view manuals and/or other technical data regarding the systems of vehicle 100, a vehicle effects application allowing the operator to view status information associated with effects system 102, a radio control application for controlling the vehicle radio system, a power management application for managing the power channels of vehicle 100, a situational awareness application for providing video surveillance and/or other information about the surroundings of vehicle 110, a digital services application, a video services application, a vehicle configuration tool, and/or any other vehicle systems applications.

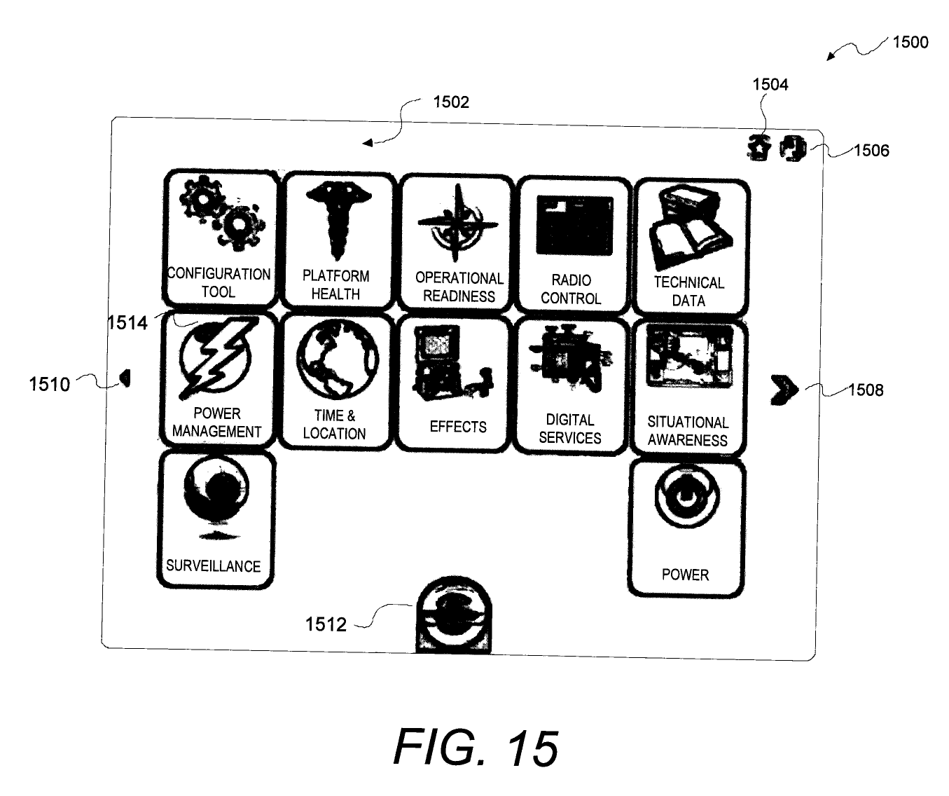

Capability action control UI elements 1502 may act as an interface allowing an operator to quickly and easily switch between capability display modules 550-558 installed on vehicle 100. FIG. 15 shows an exemplary representation of a platform capability management window 1500, which may be a “home screen” including one or more of the capability action control UI elements 1502. Management window 1500 may be displayed to an operator on a display device associated with VIT 260.

As shown in FIG. 15, window 1500 may include one or more of the capability action control UI elements 1502 allowing the operator to select and launch a desired display module 550-558 installed and available on VIT 260. Window 1500 may also include a favorites UI element 1504 allowing the operator to toggle between capability action control UI elements 1502 corresponding to capability display modules 550-558 that have been tagged as ‘favorites’, and capability action control UI elements 1504 corresponding to the full range of installed capability action control UI elements 1502 of VIT 260.

Window 1500 may also include a capability name sort control UI element 1506 allowing the operator to toggle between viewing capability action control UI elements 1502 sorted alphabetically or by configuration-order. Window 1500 may further include page forward and back control UI elements 1508, 1510 allowing the operator to view respectively subsequent and previous pages of capability action control elements 1502 corresponding to installed capability action control UI elements 1502. In addition, window 1500 may include a capability toggle control UI element 1512 to toggle the view between a display of capability management application window 1500 and a display of a window of a previously-invoked or currently-executing capability action control UI elements 1502. It is to be appreciated that window 1500 may include additional and/or different UI elements 1502 for managing system capabilities and application control for other capability action control UI elements 1502 installed on VIT 260.

In some embodiments, platform capability management GUI application 1500 may visually distinguish capability action control UI elements 1502 based on available vehicle capabilities and/or vehicle systems. For example, if a power management application is not installed, and/or if vehicle 100 does not have a power management control module 230 installed, capability action control module 1724 may inhibit display of a power management control UI element 1514 as a selectable option. The availability of a capability (e.g., power management system) may be broadcasted on and received from vehicle platforms 202-210 and reflected by capability action UI elements 1508 in a similar manner as discussed above in connection with the applications of VIT 260.

The disclosed embodiments may provide many advantages over prior art systems. For example, by providing applications configured to execute on VIT 260 that interface with multiple platforms of the vehicle, many systems of the vehicle may be conveniently controlled from a single device. Moreover, data associated with the vehicle systems may also be conveniently accessed from a single device.

Moreover, since the VIT 260 may have a layered software architecture that isolates the applications from the underlying functionality of the vehicle systems and platforms, new applications and capabilities may be easily added to the system. For example, vehicle “kits” including one or more new vehicle systems (e.g., an effects system) and/or a new applications for monitoring and/or controlling systems of the vehicle may be installed on the vehicle. The new applications and capabilities may be easily installed on VIT 260 via software updates, for example, by connecting a flash drive or other memory device containing the software update to the USB interlace of VIT 260.

In addition, since the software architecture aggregates a data message received from a platform of the vehicle, converts the message into a common system format, and provides the message to the other vehicle platforms and/or applications, and VIT 260 may seamlessly integrate data across many different vehicle platforms and/or systems. This configuration may allow the data to be easily exposed to any desired vehicle platform or network. By exposing vehicle data to the onboard network, as described above, mission related information may be easily accessed from a computing device (e.g., laptop) connected to the onboard network (e.g., via Ethernet). For example, a passenger aboard vehicle may be able to access over the network web services or “web pages” providing GPS data, automotive data, effects data, mission data, and/or other data associated with the vehicle using his or her own computing terminal.

One skilled in the art will appreciate that computer programs for implementing the disclosed processes may be stored on and/or read from computer-readable storage media. The computer-readable storage media may have stored thereon computer-executable instructions which, when executed by a computer having a processor, cause the computer to perform, among other things, the processes disclosed herein. Exemplary computer-readable storage media may include magnetic storage devices, such as a hard disk, a floppy disk, magnetic tape, or another magnetic storage device known in the art; optical storage devices, such as CD-ROM, DVD-ROM, or another optical storage device known in the art; and/or electronic storage devices, such as EPROM, a flash drive, or another integrated circuit storage device known in the art.

Other embodiments and advantages of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A vehicle information terminal, comprising:
a display device;
a vehicle interface connecting to a plurality of distinct vehicle communications platforms supporting a plurality of vehicle systems;
a storage device storing:
an operating system of the vehicle information terminal; and
a plurality of graphical operator interface (GUI) applications corresponding to the vehicle systems and configured to execute on the operating system; and
one or more processors configured to execute the GUI application on the operating system to:
display a GUI window on the display device, the GUI window providing for an operator's selection at least some of the plurality of GUI applications;
receive a selection by the operator of a GUI application; and
interface with the vehicle system to which the selected GUI application corresponds over the vehicle communications platform via the GUI window.

2. The vehicle information terminal of claim 1, wherein:
the vehicle systems are configured to communicate data associated with the vehicle systems on the vehicle communications platforms;
the selected GUI application includes at least one display operator interface (UI) element; and
the one or more processors are further configured to:
receive data from the vehicle system to which the selected GUI application corresponds, over the vehicle interlace; and
execute the selected GUI application on the operating system to display a representation of the received data in the GUI window using the UI element.

3. The vehicle information terminal of claim 2, wherein the one or more processors are further configured to execute the selected GUI application to:
translate the received data to a message having a common data format associated with the vehicle; and
provide the received message to the executing GUI application for the display of the representation of the data.

4. The vehicle information terminal of claim 2, wherein the received data includes at least one of sensor data or status information associated with the vehicle system to which the selected GUI application corresponds.

5. The vehicle information terminal of claim 1, further comprising:
an input device configured to receive input from a operator of the information terminal,
wherein the GUI application includes a control user interlace (UI) element for controlling a function of the vehicle system, and
the one or more processors are further configured to execute the selected GUI application to:
receive, via the input device, operator input to the control UI element; and
transmit, responsive to the operator input, a command on the vehicle communications platform supporting the vehicle system to which the selected GUI applications corresponds, wherein the vehicle system executes the function in response to the command.

6. The vehicle information terminal of claim 5, wherein, to generate the command, the one or more processors are further configured to execute the GUI application to:
generate, based on the input to the control UI element, a command message having a common data format associated with the vehicle;
translate the command message based on the vehicle communications platform supporting the vehicle system; and
broadcast the translated command message on the vehicle communications platform supporting the vehicle system.

7. The vehicle information terminal of claim 1, wherein the vehicle communications platforms include a first controller area network (CAN) communications platform, a second controller area network (CAN), a binary serial communications platform, and an onboard local area network (LAN) platform.

8. The vehicle information terminal of claim 7, wherein the first CAN platform supports automotive systems of the vehicle and the second CAN platform supports mission-related systems of the vehicle.

9. The vehicle information terminal of claim 1, wherein the operating system includes an embedded operating system of the vehicle information terminal and a mobile operating system operating within the embedded operating system, and the plurality of GUI applications is configured to execute on the mobile operating system.

10. An vehicle information terminal, comprising
a display device;
a first vehicle interface connecting to a first vehicle communications platform supporting a first set of vehicle systems;
a second vehicle interface connecting to a second vehicle communications platform supporting a second set of vehicle systems;
a storage device storing:
an operating system of the information terminal;
a mobile operating system executing within the operating system of the vehicle information terminal;
a first graphical operator interface (GUI) application associated with a first vehicle system in the first set of systems and configured to execute on the mobile operating system; and
a second GUI application associated with the a second vehicle system in the second set of systems and configured to execute on the mobile operating system; and
one or more processors configured to execute the first and second GUI applications on the mobile operating system to:
display first and second GUI windows on the display device associated respectively with the first and second vehicle systems; and
interface respectively with the first and second vehicle systems over the first and second vehicle communications platforms via the first and second GUI windows.

11. The vehicle information terminal of claim 10, wherein:
the first vehicle system is configured to communicate first data associated with the first vehicle system on the first communications platform;
the second vehicle system is configured to communicate second data associated with the second vehicle system on the second communications platform;
the first and second GUI applications include respective first and second display operator interface (UI) elements; and
the one or more processors are further configured to:
receive the first and second data respectively over the first and second vehicle interlaces; and
execute the first and second GUI applications on the operating system to display representations of the received first and second data respectively in the first and second GUI windows using the first and second display UI elements.

12. The information terminal of claim 11, wherein the one or more processors are further configured to execute the first and second GUI applications to:
translate the first data to a first message having a common data format associated with the vehicle;
translate the second data to a second message having the common data format associated with the vehicle; and
provide the translated first and second data respectively to the first and second GUI applications for the display of the representations of the first and second data.

13. The vehicle information terminal of claim 11, wherein the first and second data include at least one of sensor data or status information associated respectively with the first and second vehicle systems.

14. The vehicle information terminal of claim 10, further comprising:
an input device configured to receive input from a operator of the information terminal,
wherein the first and second GUI applications include first and second control operator interface (UI) elements for controlling respective functions of the first vehicle system and the second vehicle system, and
the one or more processors are further configured to execute the first and second GUI applications to:
receive, via the input device, operator input to the first control UI element and to the second control UI element; and
transmit, responsive to the operator input, first and second commands respectively on the first and second vehicle communications platforms to the first and second vehicle systems to execute the functions.

15. The vehicle information terminal of claim 14, wherein, to generate the first and second commands, the one or more processors are further configured to execute the first and second GUI applications to:
generate, based on the input to the first control UI element, a first command message having a common data format associated with the vehicle;
generate, based on the input to the second control UI element, a second command message having the common data format associated with the vehicle;
translate the first and second command messages based on the first and second vehicle communications platforms, respectively, to a common vehicle data format; and
broadcast the translated first and second command messages respectively on the first and second vehicle communications platforms.

16. The information terminal of claim 10, wherein the first and second vehicle communications platforms include a controller area network (CAN) communications platform, a binary serial communications platform, or an onboard local area network (LAN) platform.

17. The vehicle information terminal of claim 10, wherein the first platform supports automotive systems of the vehicle and the second platform supports mission-related systems of the vehicle.

18. A method for integrating systems of a vehicle using a vehicle information terminal, comprising:
using a first vehicle interface, connecting to a first vehicle communications platform supporting a first set of vehicle systems;
using a second vehicle interface, connecting to a second vehicle communications platform supporting a second set of vehicle systems;
executing, by one or more processors, an operating system of the information terminal;
executing, by the one or more processors, a mobile operating system on the operating system of the vehicle information terminal; and
executing, by the one or more processors on the mobile operating system, a first graphical operator interface (GUI) application associated with a first vehicle system in the first set of systems and a second GUI application associated with the a second vehicle system in the second set of systems on the mobile operating system to:
display first and second GUI windows on a display device associated respectively with the first and second vehicle systems; and
interface respectively with the first and second vehicle systems over the first and second vehicle communications platforms via the first and second GUI windows.

19. The method of claim 18, wherein the first and second vehicle communications platforms include a controller area network (CAN) communications platform, a binary serial communications platform, or an onboard local area network (LAN) platform.

20. The method of claim 19, wherein the first platform supports automotive systems of the vehicle and the second platform supports mission-related systems of the vehicle.

21. A method for integrating systems of a vehicle using a vehicle information terminal, comprising:
using a vehicle interface, connecting to a plurality of distinct vehicle communications platforms supporting a plurality of vehicle systems;
executing, by at least one processor, a mobile operating system of the vehicle information terminal; and
receiving from an operator a selection of one of a plurality of graphical operator interface (GUI) applications for interfacing with one or more of the vehicle systems; and
executing the selected GUI application on the mobile operating system to interface, over the vehicle communications platform, with a vehicle system of the plurality of vehicle systems to which the selected GUI application corresponds.
